(19) United States
(12) Patent Application Publication
(10) Pub. No.: US 2024/0119497 A1
(43) Pub. Date: Apr. 11, 2024

(54) SHOPPING DIRECTLY FROM USER SCREEN WHILE VIEWING VIDEO CONTENT OR IN AUGMENTED OR VIRTUAL REALITY

(71) Applicant: DroppTV Holdings, Inc., New York, NY (US)

(72) Inventors: Harpreet Singh Geekee, Ontario (CA); Gurpreet Singh Rai, Edgewater, NJ (US); Christopher James Kelly, Brooklyn, NY (US)

(21) Appl. No.: 18/535,880

(22) Filed: Dec. 11, 2023

Related U.S. Application Data
(63) Continuation of application No. 17/232,034, filed on Apr. 15, 2021, now abandoned.
(60) Provisional application No. 63/010,612, filed on Apr. 15, 2020.

(51) Int. Cl. G06Q 30/0601; G06F 18/21; G06F 18/22; G06N 3/04; G06N 3/08; G06Q 30/0202; G06V 10/44; G06V 10/764; G06V 10/82; G06V 20/20; G06V 20/40

(52) U.S. Cl. CPC G06Q 30/0605; G06F 18/21; G06F 18/22; G06N 3/04; G06N 3/08; G06Q 30/0202; G06Q 30/0623; G06Q 30/0631; G06Q 30/0641; G06V 10/454; G06V 10/764; G06V 10/82; G06V 20/20; G06V 20/41; G06Q 20/12

(57) ABSTRACT

According to some embodiments, in an environment where one or more users can view video content on respective user systems, wherein each user system comprises a display screen, systems and methods are provided for enabling at least one user to shop directly from the display screen on a respective user system while viewing video content.

### CROSS REFERENCE TO RELATED APPLICATIONS

This application claims the benefit under 35 U.S.C. § 120 as a Continuation of U.S. patent application Ser. No. 17/232,034, filed Apr. 15, 2021, which claims the benefit of U.S. Provisional Application No. 63/010,612, filed on Apr. 15, 2020, the entire contents of which are hereby incorporated by reference as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to computer vision and electronic commerce (“e-commerce”), and in particular, shopping directly from a user screen while viewing a video program or in augmented or virtual reality.

### BACKGROUND

Electronic commerce (“e-commerce”) has developed to allow users to view and shop for goods or services on-line, without the need to visit physical (“brick and mortar”) stores. In a typical e-commerce experience, a user will interact through the Internet with an on-line website using a computer with a respective display screen. In many cases, the same or different computer with display screen may also be used by the user to watch various video programs (either streaming or stored). While watching a video program, the user may see items, such as clothes, shoes, food, automobiles, etc. which the user may be interested in purchasing. However, despite the fact that the same or similar computer and display screen is used for both e-commerce and video program viewing, the user is not able to purchase or find out more information about such items of interest directly from the video program. Instead, the user must resort to taking screen shots of the items and then performing tedious, manual searches for similar images on the Internet. As such, there are distinct processes and technologies that are missing in the current e-commerce and video environments.

### BRIEF DESCRIPTION OF THE DRAWINGS

FIG. 1A illustrates an exemplary environment in which the computerized systems and methods for entertainment commerce can operate or be used, in accordance with some embodiments.

FIG. 1B is a block diagram of a computing device, according to some embodiments.

FIGS. 2 and 3 illustrate a network or architecture for systems and methods to make any display screen shoppable, according to some embodiments.

FIG. 4 illustrates a user interface, according to some embodiments.

FIG. 5 illustrates user interface layers, according to some embodiments.

FIG. 6 illustrates dashboard services, according to some embodiments.

FIG. 7 illustrates an administrative interface, according to some embodiments.

FIGS. 8 and 9 illustrate systems and methods for identity management for various users, according to some embodiments.

FIG. 10 illustrates systems and methods for management for end to end security, according to some embodiments.

FIG. 11 illustrates a micro-services model, according to some embodiments.

FIGS. 12 and 13 illustrate systems and methods for application programming interface (API) management, according to some embodiments.

FIG. 14 illustrates systems and methods for data layer management, according to some embodiments.

FIG. 15 illustrates systems and methods for platform management by a community, according to some embodiments.

FIG. 16 illustrates object detection and classification, according to some embodiments.

FIG. 17 illustrates artificial intelligence (AI)/machine learning (ML) for object detection and classification, according to some embodiments.

FIG. 18 illustrates a multi-layer neural network, according to some embodiments.

FIG. 19 illustrates systems and methods for precision marketing, according to some embodiments.

FIGS. 20A, 20B, 21, and 22 illustrate systems and methods augmented reality (AR) shopping, according to some embodiments.

FIG. 23 illustrates a rules and policy engine, according to some embodiments.

### DETAILED DESCRIPTION

This description and the accompanying drawings that illustrate aspects, embodiments, implementations, or applications should not be taken as limiting the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

According to some embodiments, systems and methods are provided to make any display screen shoppable. In some embodiments, the systems and methods provide for commerce while users are being entertained (i.e., “Entertainment Commerce”). In some embodiments, the systems and methods of the present disclosure, or portions thereof, can be implemented or made available on one or more computing modules, processes, or devices—such as laptop, desktop, tablet, smart telephone, smart television, server, cluster, and software or processes running thereon.

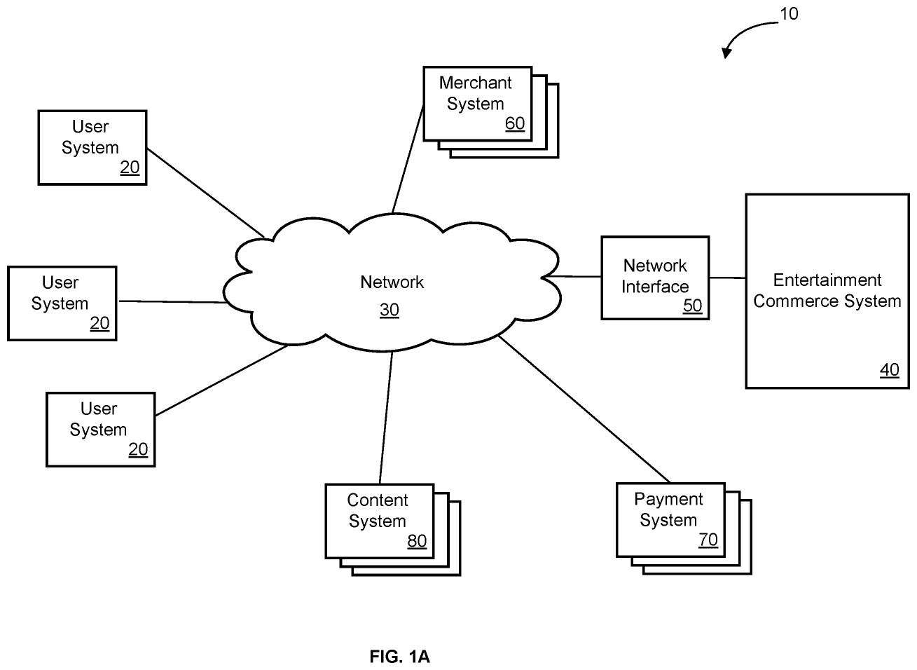

FIG. 1A illustrates an exemplary environment 10 in which the computerized systems and methods for Entertainment Commerce can operate or be used, in accordance with some implementations. In some embodiments, environment 10 can implement an architecture or platform where one or more users and merchants of services and goods can interact and engage in Entertainment Commerce. As shown in FIG. 1, environment 10 may include user systems 20, network 30, Entertainment Commerce system 40, network interface 50, merchant systems 60, payment systems 70, and content systems 80. In other implementations, environment 10 may not have all of these components and/or may have other components instead of, or in addition to, those listed above.

User systems 20 allow or enable respective users to interact with other entities in the environment 10. The users can be prospective purchasers of goods and services from the various merchants. In some embodiments, each user system 20 includes at least one display screen on which the user may view or watch entertainment, such as video segments, television shows, movies, concerts, etc., and/or augmented reality, or other content.

Each user system 20 may be implemented as any computing device(s) or other data processing apparatus such as a machine or system that is used by a user, for example, to access a storage or processor system implementing entertainment commerce system 40. For example, any of user systems 20 can be a handheld computing device, a mobile phone, a laptop computer, a work station, tablet, personal device assistant (PDA), wireless access protocol (WAP) enabled device or any other computing device, and/or a network of such computing devices, capable of interfacing directly or indirectly to the Internet or other network connection, allowing a user of user system 20 to access, process and view content and other information, pages and applications available to it from any of system 40, merchant systems 60, payment systems 70, and content systems 80 over network 30.

In some examples, each user system 20 may include one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by any of system 40, 60, 70, 80 or other systems or servers. For example, the user interface device can be used to access data and applications hosted by system 40, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

User systems 20 may each also include wireless communication equipment comprising or implemented with one or more radios, chips, antennas, etc. for allowing the user systems 20 to send and receive signals for conveying information or data to and from other devices or computing systems. Under the control of the system's processor, wireless communication equipment may provide or support communication over Bluetooth, Wi-Fi (e.g., IEEE 802.11p), and/or cellular networks with 3G, 4G, or 5G support.

Content systems 80 allow or enable respective content providers to interact with other entities in the environment 10. In some examples, a content provider can be any provider of content which one or more users may elect or choose to view or stream, such as, for example, movies television shows, etc. In some embodiments, content systems 80 are used by content providers to upload content for processing or combining with other data or information, e.g., from merchants, before viewing by users through user systems 20. The content may feature or include images of various items or merchandise, such as clothing, shoes, fashion items, food, beverages, etc., for example, being worn or consumed by an actor or celebrity. This merchandise, or similar or related items, may be available or offered by respective merchants.

Merchant systems 60 allow or enable such merchants to interact with other entities in the environment 10. In some examples, a merchant can be any retailer, venue, vendor, or seller offering merchandise or services, which may appear, be included, or featured in content viewed by a user. Through merchant system 60, merchants can provide or supply information or data for images, prices, availability, store locations, SKU numbers, sizing, etc. for one or more items of merchandise or services offered by the merchant. Merchant systems 60 also can receive orders or queries from users or other entities in the environment 10, for example, for order fulfillment. Payment system 70 allows a payment processing entity to interact in the environment 10, for example, to process payments made by users ordering products or services in Entertainment Commerce.

Entertainment commerce system 40 supports Entertainment Commerce. In Entertainment Commerce, users can shop directly from the screens on their user systems 20 while watching a video and other multi-media programs (e.g., TV show, movie, augmented and/or virtual reality based interactions, etc.). In some embodiments, entertainment commerce system 40 implements a platform or architectures, with associated systems and methods, which cooperates or works in conjunction with the other systems in environment 10, to allow a user to seamlessly shop, buy, and/or ship a desired product mid-stream or mid-view in a program (e.g., a user can buy the particular sweatshirt that a pop artist is wearing in streamed concert performance right from the user's display screen). As such, platform or architecture substantially reduces or eliminates the need for a user to take screen shots or perform tedious image searches for an item of interest that has been shown in a program.

Network 30 can be any network or combination of networks of devices that communicate with one another. For example, network 30 can be any one or any combination of a LAN (local area network), WAN (wide area network), telephone network, wireless network, point-to-point network, star network, token ring network, hub network, or other appropriate configuration. Network 30 can include a TCP/IP (Transfer Control Protocol and Internet Protocol) network.

Network interface 50 provides or supports communications, signaling, etc. between the network 30 and system 40. Network interface 50 supports, provides, or implements an interface for entertainment commerce system 40 to interact or communicated with the other entities in environment 10 through network 30. In some examples, network interface 50 can comprise or be implemented using one or more HTTP servers. In some embodiments, the network interface 50 provides or includes load sharing functionality, such as load balancing and distribute incoming HTTP requests over a plurality of servers at system 40.

In some examples, one or more user systems 20 can communicate with system 40 through the network 30 and network interface 50 using TCP/IP and, at a higher network level, use other common Internet protocols to communicate, such as HTTP, FTP, AFS, WAP, etc. In an example where HTTP is used, user system 20 might include an HTTP client commonly referred to as a “browser” for sending and receiving HTTP signals to and from an HTTP server at storage and/or processor system implementing system 40.

In some embodiments, the systems and methods of the present disclosure, or portions thereof, can be implemented in one or more neural networks or associated models. In general, neural network models receive input information and make predictions and recommendations based on the input information. Neural networks learn to make predictions gradually, by a process of trial and error, using a machine learning process.

In some embodiments, each of user systems 20, merchant systems 60, payment systems 70, and entertainment commerce system 40 can be implemented with one or more computing devices or other data processing apparatuses, such as, for example, described in more detail with respect to FIG. 1B.

FIG. 1B is a simplified diagram of a computing device 100 according to some embodiments. As shown in FIG. 1, computing device 100 includes a processor 110 coupled to memory 120. Operation of computing device 100 is controlled by processor 110. And although computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs), video processing units (e.g., video cards), and/or the like in computing device 100. Computing device 100 may be implemented as a stand-alone subsystem, as a board added to a computing device, and/or as a virtual machine.

Memory 120 may be used to store software executed by computing device 100 and/or one or more data structures used during operation of computing device 100. Memory 120 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 110 and/or memory 120 may be arranged in any suitable physical arrangement. In some embodiments, processor 110 and/or memory 120 may be implemented on a same board, in a same package (e.g., system-in-package), on a same chip (e.g., system-on-chip), and/or the like. In some embodiments, processor 110 and/or memory 120 may include distributed, virtualized, and/or containerized computing resources. Consistent with such embodiments, processor 110 and/or memory 120 may be located in one or more data centers and/or cloud computing facilities.

In some embodiments, processor 110 and/or memory 120 may implement one or more neural networks, as described further herein. In some examples, the neural networks may include a multi-layer or deep neural network, a Region-based Convolutional Neural Network (R-CNN), and/or other suitable network. In some embodiments, a first neural network (e.g., a CNN) can be used to identify various objects in a video frame or image, and a second neural network can be employed to match the identified object to a sellable item in the inventory of one or more vendors or merchants.

In some examples, memory 120 may include non-transitory, tangible, machine readable media which includes executable code that when run by one or more processors (e.g., processor 110) may cause the one or more processors to perform the shoppable video methods or processes described in further detail herein. In some embodiments, these methods or processes are implemented, at least in part, in one or more suitable computer modules, such as, for example, shoppable video module 130, executing the algorithms and methods described herein. In some embodiments, additional memory may be used or included (e.g., off-board) for video, augmented or virtual reality, metadata, log and analytical data.

In some examples, shoppable video module 130 may be implemented using hardware, software, and/or a combination of hardware and software. In some examples, shoppable video module 130 may also handle the iterative training and/or evaluation of a neural network model used to implement the systems and processes described herein. As shown, computing device 100 receives input data 140, which may be provided to shoppable video module 130, which then generates or provides output data 150 based on and/or in response to the same.

Input data 140 can include data relating to one or more video segments. In some embodiments, these video segments can relate to video or multi-media programs that is provided, developed, or originates from a content provider (e.g., such as a movie or television studio, sports broadcaster, concert promoter, etc.). The multi-media programs, such as movies, television shows, concerts, sporting events, etc., can be downloaded and stored, or live-streamed to a user's computer (e.g., user system 20) with suitable display screen for viewing the same. In some embodiments, these video segments can relate to or include video that is taken or recorded by the users themselves on respective computing devices, for example, as the user is traversing or visiting some location (e.g., Times Square in New York City) where the user might encounter or see various items or objects of interest (such as an item of apparel being worn by another person). Such user video or multi-media can be the bases for one or more augmented reality (AR) scenarios of applications. In some embodiments, the video or multi-media can also comprise content for one or more virtual reality (VR) scenes, e.g., in which various users, actors, performers, etc. may participate or be represented with suitable avatars.

According to some embodiments, systems and methods of the present disclosure extend the multi-media programs (e.g., from content providers or users) with metadata. In particular, the input data 140 may also include data for objects or items displayed or presented in the video segments or programs, and of potential interest to one or more users, such as clothing, shoes, food, beverages, automobiles, etc. In some embodiments, input data 140 can include data from various viewers, users, communities, social influencers, artists, etc. working in conjunction with, or processed or analyzed by, one or more artificial intelligence networks (e.g., social assisting AI) to learn or identify the products or items. Input data 140 can also include data relating to input from one or more users—e.g., for selecting, viewing, “trying on,” and/or purchasing one or more items of interest. For example, the input data 140 may include a user's specific body dimensions (e.g., head, neck, chest, waist, inseam, sleeve length, shoe size and width, etc.) or type (e.g., “petite,” “slim,” “full-figured,” “athletic,” etc.). The input data 140 may also comprise date or information provided by or received from one or more vendors or sellers of the various items presented, displayed, or captured in the video segments or programs, including, for example, vendor identification (e.g., brand name or label), item identification or stock numbers, size options, color options, information about fit (e.g., “full,” “relaxed,” “straight,” “tapered,” “slim,” “skinny,” or “form” fit), pricing information, menu items, complementary items, availability, store or restaurant locations, shipping or delivery costs and times, etc.

Output data 150 can include data relating to one or more items or objects that the system has identified within the one or more video segments or programs, and connections or relationships of the identified items to products or services being offered by one or more vendors or sellers. That is, in some embodiments, output data 150 includes data for matching over live/recorded video to the inventory of various providers. Output data 150 can also include data or information for links or triggers to embed or include into the one or more video programs proximate in time and/or location to certain objects or items, such links or triggers “clickable” by a user or viewer so that information regarding the object may be presented or displayed to the user, e.g., for potential purchase. In some embodiments, the output data 150 may include one or more portions of the video programs themselves into which the links or triggers relating to certain items are inserted. The output data 150 may also comprise data that can be sent to a vendor or seller for the ordering of various items or objects displayed in the video programs, or obtaining additional information regarding same.

In some embodiments, the one or more computer systems or neural networks implement an architecture, network, or platform for shopping directly from a user screen while viewing a video program. In some embodiments, this architecture or platform implements or achieves various principles: (1) Modularity—ability to integrate and leverage third party systems, and other new innovations—core platform focuses on the key capabilities of aggregating demand, providing excellent customer service, minimizing overhead, smart campaign, transparent transaction execution etc. (2) Scalability—vertical & horizontal—24×7 operations—although initial deployments are United States, the scale of transactions can be large and need to scale effectively. (3) Simplicity—KISS—End user utilization should be “obvious” and minimal disruption—in case of business-to-business (B2B), at least some of the end users can be considered or comprise manufacturers, enterprises, vendors, sellers, distributors, or other merchants The disruptions to their existing procedures should have minimal learning curve. (4) Security—All activities need to be secure—data (anonymized), transactions (secured), execution (encrypted), information (distributed).

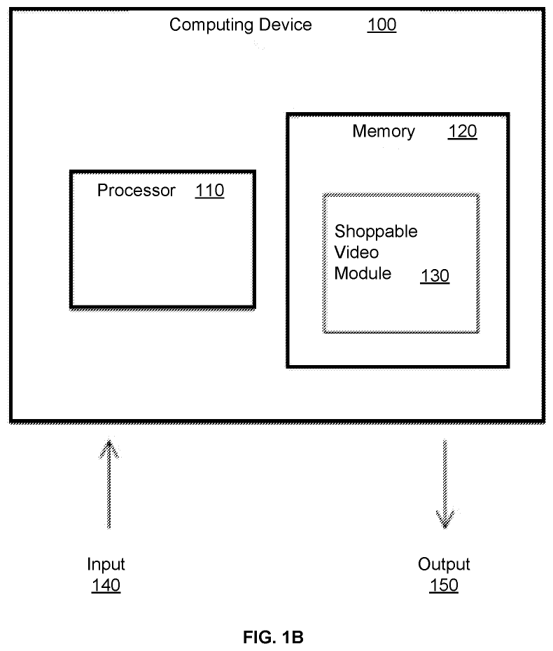

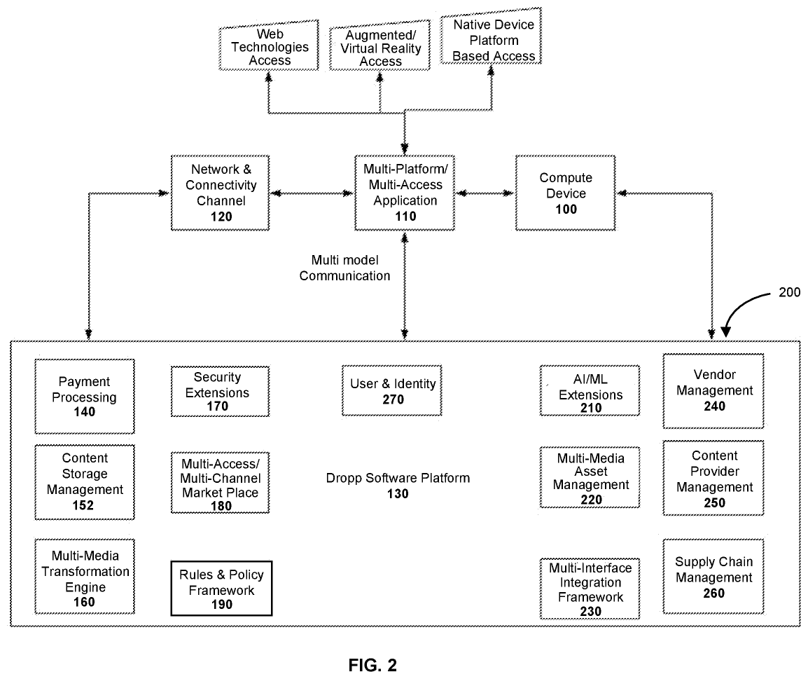

High-level overviews of the architectural, functional, and hardware/software components of the network, architecture, or platform (e.g., as implemented by one or more computing systems or neural networks) for supporting or implementing the Entertainment Commerce experience, according to some embodiments, are provided in FIGS. 2 and 3.

Referring to FIG. 2, a network or architecture 200 is shown for the systems and methods to make any display screen shoppable, according to some embodiments. The network or architecture 200 can be accessed in one or more ways, including web technologies access (e.g., Internet), augmented or virtual reality access, or native device platform based access. Access is provided to one or more users, administrators, merchants, content providers, payment providers, etc. through suitable interfaces (e.g., graphical user interfaces (GUIs)) available or supported on respective user systems 20, merchant systems 60, content systems 80, payment systems 70, etc. In some embodiments, such access is provided, controlled, maintained, or regulated through a multi-platform/multi-access application 110, which can work in conjunction or cooperation with network connectivity channel 120 and computing device 100, and through, e.g., a multi-modal or other suitable connection, to communicate (e.g., input and output data and information) with a computing platform 130. In some embodiments, the computing platform 130 implements or supports the entertainment commerce system 40 and/or shoppable video module 130 of FIGS. 1A and 1B.

Referring to FIGS. 2 and 3, in some embodiments, the architecture or network, including platform 130, provides or supports a framework to integrate external services—e.g., payment gateway, data anonymizer, security key management, fulfillment system integration, logistics and supply chain (third party logistics (3PL) or fourth party logistics (4PL)) interface integrations, manufacturer ordering system integration etc. In some embodiments, the external framework can be application programming interface (API) and workflow driven integration. The external framework enables or supports complete lifecycle, including the ability to handle multiple versions of the integrations, deprecated interfaces, etc. It also may support or facilitate complete end-to-end encryption based on token, certificates and/or encryption strategies. In some embodiments, primary interfaces for the external framework can be based on RESTful APIs, leveraging JSON and other mechanism to transfer/access data. Such framework may include support to integrate micro-services (third party) and orchestrate by leveraging appropriate container orchestration technologies.

According to some embodiments, the network, architecture, or platform 130, implementing one or more systems and their corresponding methods, provide or allow for instant purchasing power by one or more users or viewers of video segments or programs.

In some embodiments, the systems and methods provide or implement a marketplace where multi-media assets (video, virtual reality (VR), augmented reality (AR), pictures, etc.) are shoppable. In some embodiments, the systems and methods enable any authorized merchant, vendor, seller, or participant to create a virtual shoppable multimedia store. Such store provides the visual and other sensory insights into the products or services that can be sold off from the marketplace vendor. The store can also be extended or enabled using, for example, AR and 3D modelling techniques.

To this end, with reference to FIG. 2, computer platform 130 of the network or architecture can be implemented with some combination of hardware and software (e.g., similar to that described for computing device 100 with reference to FIG. 1) for performing the tasks, routines, and operations for Entertainment Commerce, as implemented, for example, in the various modules, systems, networks as further described herein. These include payment processing 140, content storage management 152, multi-media transformation engine 160, security extensions 170, multi-access/multi-channel market place 170, rules and policy framework 190, multi-interface integration framework 200 or 230, AI/ML extensions 210, multi-media asset management 220, vendor management 240, content provider management 250, and supply chain management 260.

In some embodiments, the systems and methods gives users or audiences the ability to see a product while watching any form of live or pre-recorded media (e.g., as stored, maintained or otherwise managed in content storage management 150 or multi-media asset management 220), and buy it instantly. Using a cursor (e.g., while accessing the network or platform via web technologies access or native device platform based access), consumers can hover or select by any other means, click and buy any experience, product or service they are viewing—e.g., consumers can shop an item of interest from their favorite athlete, home decor show, or reality series with the click of a button.

In some embodiments, the systems and methods of the present disclosure can be used or employed by content providers or creators (working in collaboration or conjunction with various vendors or sellers) to create a new mode of digital interaction that allows the creators (and brands) to monetize their video programs (e.g., television shows and movies) through smart video technology, powered by or implemented in artificial intelligence and neural networks 302. As such, the creator first model of the present disclosure disrupts traditional advertising, retail and video paradigms, inspires multifaceted community-based revenue, and invigorates the cultural energy behind all commerce.

To provide for this, the systems and methods of the present disclosure—e.g., as implemented by the modules and processes of the network and platform 130 of FIG. 2, as further described herein—can identify objects in one or more video segments, make them “clickable.” In some embodiments, the systems and methods implement or provide the ability to detect an object (e.g., item of apparel) in a video stream (live or pre-recorded) and match it with one or more objects from a commerce-platform inventory so that the item may be readily purchased by the user. In some examples, this ability or operation is supported or implemented by multi-media transformation engine 160 and AI/ML extensions 210. In some embodiments, the same concept of marketplace is extended in the AR (Augmented Reality) domain, by leveraging various trigger to enable products that can be “inspected,” “tried,” and purchased. That is, in some embodiments, the augmented reality extension to the marketplace to inventory items or assets allows the consumer or any user to “try-on,” visualize, or otherwise experience the assets in their own personalized environment (i.e., on a virtual version of the user's self or on someone else, in the environment (such as room, place, landscape etc.)).

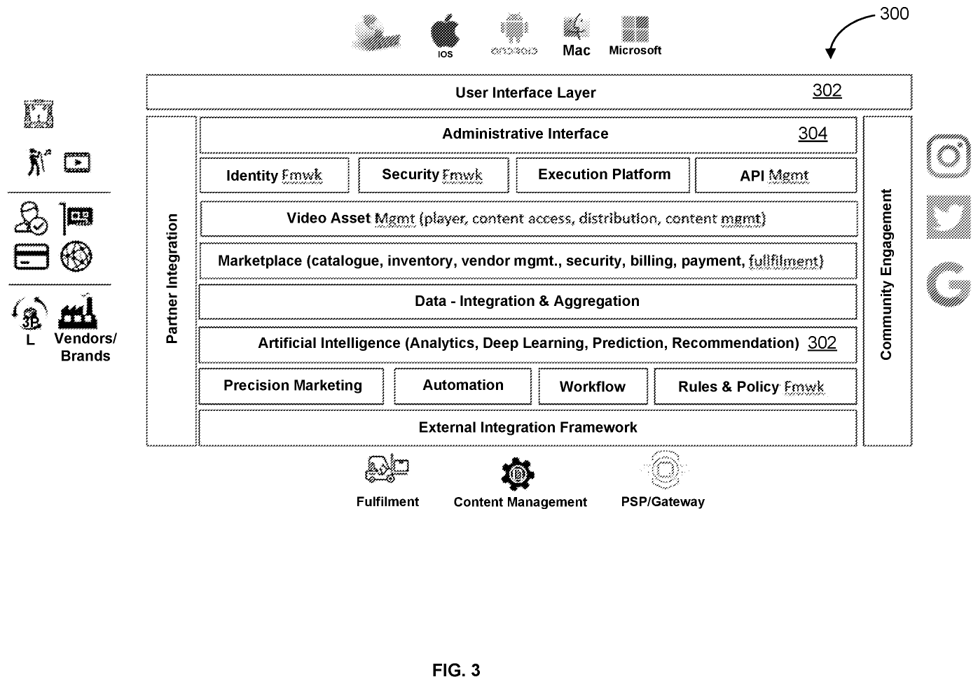

In some embodiments, for allowing the relevant or interested parties to interact with the systems, networks, architecture, and platform of the present disclosure, one or more secure and interface (I/F) communications are provided. In some examples, these interfaces can be implemented or incorporated in the multi-platform/multi-access application 110, multi-interface integration framework 200, multi-access/multi-channel market place 180, multi-interface integration framework 230 (FIG. 2) of the network or architecture. As shown in FIG. 3, these interfaces may include one or more of each of a user interface 302, administrative interface 304, marketplace interface, and operations interface. Embodiments of the interface and related layers are shown in FIGS. 4, 5, 6, and 7.

In some embodiments, the user interface allows one or more users to interact with the multi-channel platform or architecture (e.g., platform 130 of FIG. 2). In general, such users can be end-users (e.g., viewers of content or multi-media), merchants, content providers, payment providers, administrators, or any other entity that interacts with or accesses the platform 130 to use or deliver the services and operations described herein. As shown in FIG. 4, in some embodiments, the user interface 400 can be provided, implemented, or accessed with or through a computing device 100, which can implement or incorporate, e.g., any of user system 20, merchant system 60, content system 80, payment system 70. In some embodiments, user interface 400 implements, provides, or supports a user interface 302.

For secure communication 402, the user interface 400 includes or is implemented with one or more modules, processes, or routines. These include cryptology 404 based on rules and policies for, e.g., the particular device, channel, user preference, multi-media stream, content provide, and other factors. For this, platform or network may store or maintain data and information relating to various rules and policies, configurations, and systems. In some embodiments, secure communication implements or uses multi-factorial authentication 406, such as, for example, third party token based authentication, biometrics driven authentication (e.g., fingerprint or facial recognition), and/or shared secret and key based authentication. In some examples, at least some of the security processes, operations, communications, etc. are implemented in or supported by security extensions 170 of the platform 130 (FIG. 2).

For actual interface communication 410, in some embodiments, the user interface 400 may comprise or include modules, processes, or routines for extension based native device communication and web services driven meta data communication 414 to support user or other interested party access via native device platform based access, third party operating system based access or web technologies access, respectively. In some embodiments, at least a portion of the interface processes, operations, and communications, etc. is implemented in or supported by the multi-interface integration framework 200 of platform 130. In some examples, the processes or routines for extension based native device communication can extend a device socket within a micro-service to support or provide modular communication. In some examples, for web services driven communication, meta data is used to represent multi-media content and one or more shoppable catalogs for various vendors, sellers, or merchants. Furthermore, a memory cache extension may be provided to facilitate real-time communications.

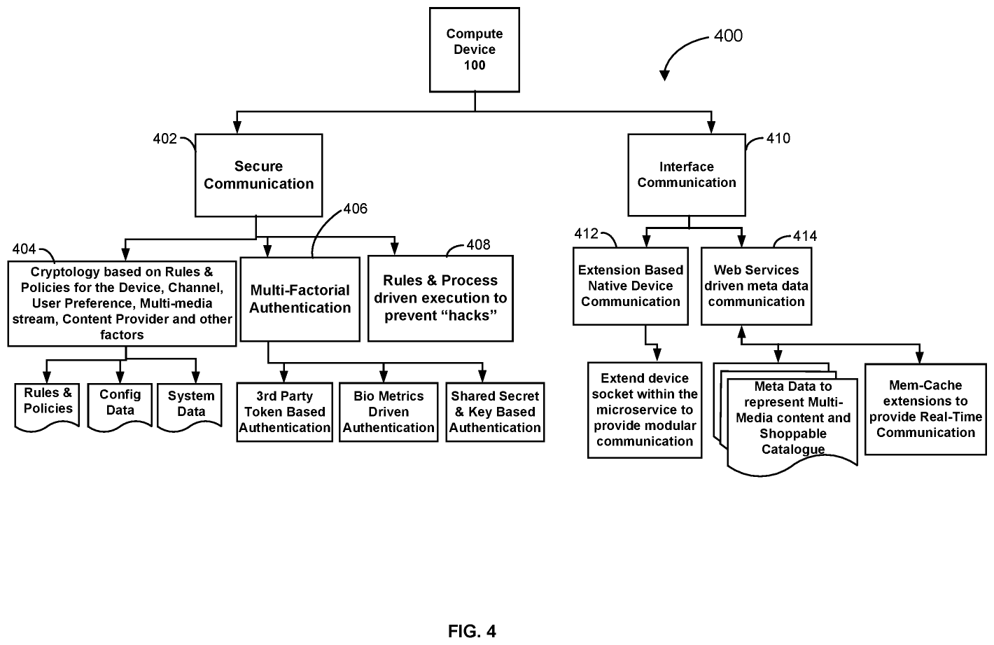

The interface communication is supported by or implemented in a user interface 400 with respective layers, an embodiment of which is shown in FIG. 5. In some embodiments, the user interface layers 500 allow one or more users (e.g., end users, merchants, content providers, payment providers, etc.) to input, view, or manage various information about or relating to the users, for example, as stored, maintained, and processed in conjunction with payment processing 140, content storage management 152, multi-media asset management 220, vendor management 240, content provider management 250, supply chain management 260, and user and identity module 270 in platform 130.

In some embodiments, user interface layer 500 can be implemented as headless access layer, responsible for enabling multiple devices and user clients (e.g., smart phones) to leverage the services. Capabilities of the user interface layer can include: (1) Abstraction—Principle of Isolation based on Interfaces (e.g. REST API's) to abstract the business flows, service execution and data access. (2) Enable the data exchange based on standard technologies like JSON, to facilitate abstraction of data. (3) Leverage the services of API Management layer—to enable life cycle management of interfaces—API versioning, API access, API deprecation etc. (4) Provide key business flows with appropriate call back mechanism to enable asynchronous communication with the User Interface implementations. (5) User Interface implementations can leverage partial set of capabilities to enable the desired services for appropriate user experience—for example, leverage intelligent matching of products or aggregation of order services, as a plugin to existing ERP or procurement engine.

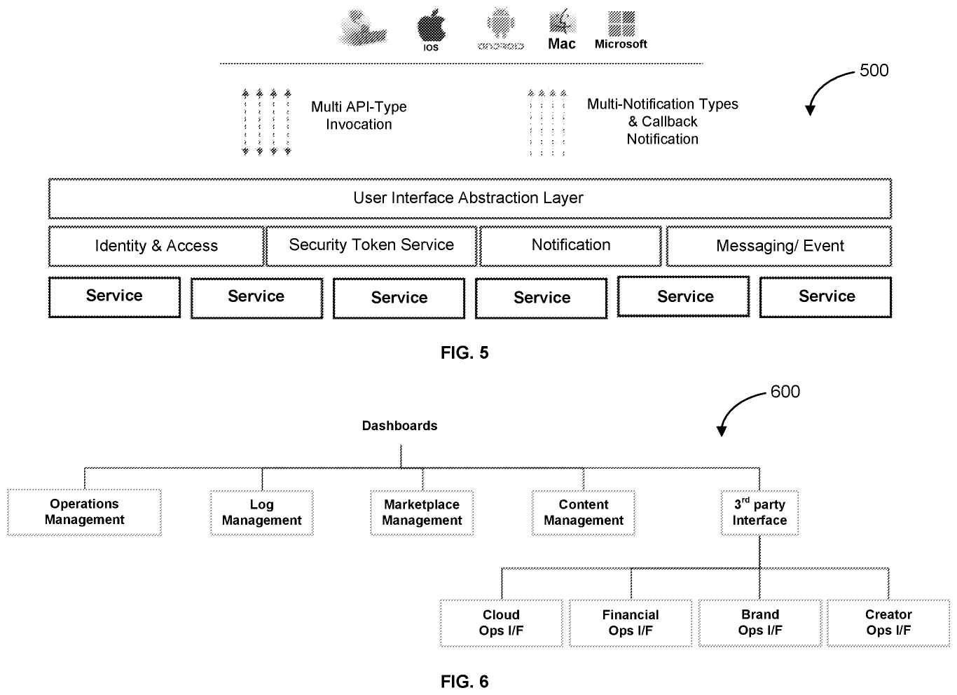

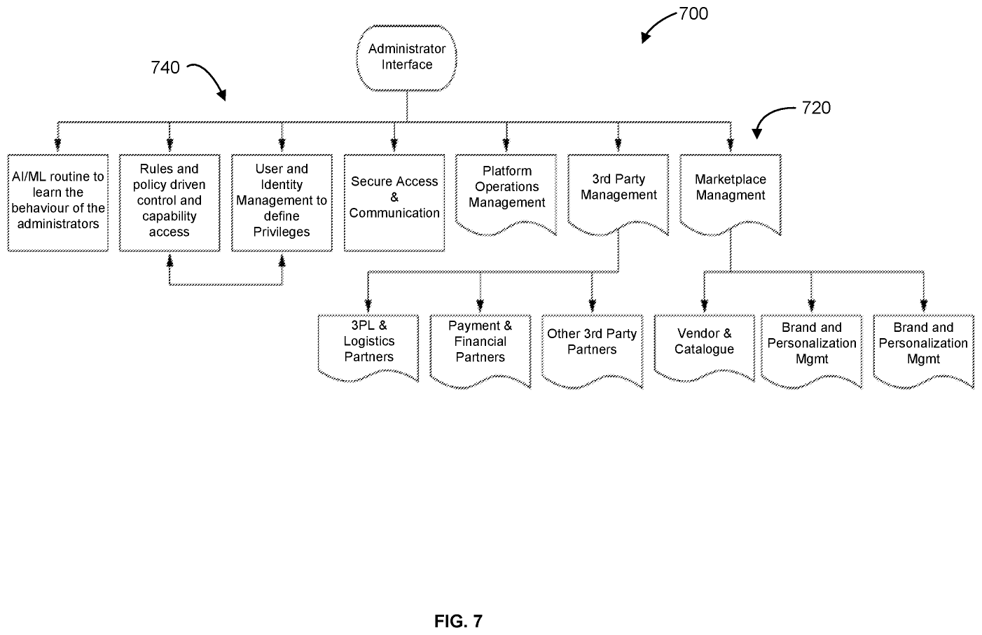

Other interfaces or interface layers for the network architecture, or platform may, in some embodiments, include an administrative interface 700, a marketplace interface, and an operations interface, which may be utilized or employed to implement or provide various dashboard services 600, as seen in FIGS. 6 and 7. In some embodiments, these dashboard services are accessible in a headless format, and may provide access into various modules of the platform 130 supporting respective processes or services. Typical services may be grouped to provide a specific set of capabilities, accessible via the corresponding interfaces.

In some embodiments, administrative (or administrator) interface 700 may provide access to security extensions 170, vendor management 240, content provider management 250, supply chain management 260 in connection with one or more administrative services. In some embodiments, administrative interface 700 implements, provides, or supports administrative interface 304. Administrative services can be used or relate to on-board, off-board various actors in the systems (e.g., enterprises, manufacturers, merchants, content providers, third party partners (such as PSP's), administrator users within organizations etc.); and further, can manage security access privileges, passwords, encryption tokens, etc.

In some embodiments, at least a portion of the administrator interface 700 implements or supports a marketplace interface 720. The marketplace interface 720 may provide access to multi-access, multi-channel market place 180 in connection with marketplace services. Marketplace services can be used or relate to asset normalization (SKU's and equivalent matching), presentation of product or item information, recommendation on the appropriate aggregations, predictions of demand, matching capabilities to aggregate and match orders, etc. The marketplace interface 720 provides or supports user or entity interaction for the key function of marketplace—i.e., to facilitate matching between various actors (e.g., buyers and sellers) in the marketplace (e.g., as implemented at least in part in the multi-access/multi-channel market place 180). To this end, the marketplace interface 720 facilitates aggregation, procurement, fulfilment, payment and aggregation. The marketplace interface may provide, support, or work in conjunction with interactions with rules and policy, vendor interfaces and fulfillment interfaces. The marketplace interface 720 supports or allows interaction for all administrative functions to manage the configuration of the marketplace. It can interact or work with third party systems to input the invoices, data input, data aggregation, etc. The marketplace interface can also be used for data access and analytics to perform the AI routines for prediction and recommendation.

In some embodiments, at least a portion of the administrator interface 700 implements or supports an operations interface 740. Operations interface 740 may provide access to the platform in support of one or more operation services. Operations services can be used or relate to the ability to scale, debug, operate the systems; leverage Manager of Manager (MoM) principals to distribute operational responsibilities between various administrators (or others) to scale; and define scope of responsibilities etc. In some embodiments, all executions are rule and policy based, and may leverage standard RBAC (Role Based Access Control) capabilities to manage access, privileges and authorizations. The operations and management interface 740, among other things, can be used to support the running and operation of the network or platform (e.g., 365 days per year, 24 hours per day, and 7 days per week, with uptime of over 99.99%). For this, the operations interface provides or supports an interface to, for example, view, manage, debug information, warnings, errors, access logs (system, application, marketplace, third party etc.), and debug all issues for the platform or architecture. It can support or provide integration with ticketing systems (internal and third party) to track and monitor the severity of issues and bugs. The operations interface 740 can provide or support an interface to upgrade and patch software, firmware and operating systems for one or more computing devices in the network or architecture. It can serve as an interface to configure, manage, and/or operate cloud infrastructure, network connectivity, including access to various third party tools from the infrastructure providers. The operations interface 740 provides or supports the ability to monitor transactions (success & failures), for example, to ensure all transactions execute seamlessly. This interface can be used for integration with various notification mechanisms, to notify appropriate resources for escalation and resolution. Embodiments for operations interface 740, the functions/operations it supports, and components accessed are shown in FIGS. 6 and 7.

The administrative interface 700 may comprise interfaces to manage the on-boarding, off-boarding, account management etc. of all actors and participants of the platform, architecture, or network 130. The administrative interface 700 provides or supports user or entity interaction for administrative functions to manage the configuration of the platform such as, for example, information management, rules and configuration management, roles and access management. The administrative interface may also support management of various relationships and data, e.g., as implemented or incorporated in content storage management 150, multi-media asset management 220, vendor management 240, content provider management 250, and supply chain management 260 (FIG. 2). In some embodiments, the administrative interface may be combined, incorporate, or work in conjunction with the operations interface.

The administrative interface 700 may also include one or more interfaces with accounting, payment, contract services, etc., as well as interfaces to track, visualize and generate reports for utilization, prediction, recommendation, etc. The administrative interface may provide or support key interactions with identity, rules & policies, execution and workflow, security & authentication, and data access layers of the architecture or platform (e.g., as show in FIGS. 2 and 3).

An embodiment for the administrative or administrator interface is shown in FIG. 7. The administrator interface includes or is implemented with one or more modules, processes, or routines. These can include an AI/ML routine (e.g., as implemented or supported in AI/ML extensions 210 of platform 130 of FIG. 2) to learn the behavior of various administrators. The interface may also implement rules and policy driven control and capability access, working in conjunction with user and identity management 270 to define and execute on privileges granted to various users. Secure access and communication and platform operations management can be supported via the administrative interface 700. The interface also provides or supports the management of third parties which, in some examples, includes 3PL and logistics partners, payment and financial partners, and other third party partners. The administrative interface 700 may also provide or support further management of the Entertainment Commerce marketplace, for example, by providing access for managing or maintaining data and information for vendors and their catalogs, brand and personalization (e.g., in the multi-access/multi-channel market place 180).

In some embodiments, access to the various methods and systems, including the network, architecture, or platform described herein, by way of the different interfaces are managed and made secure, for example, as implemented in part by one or more security extensions 170 (FIG. 2). In some embodiments, this is accomplished by managing the identities of the various parties (e.g., users, vendors, sellers, infrastructure providers, etc.) accessing, interacting, or using the platform or architecture, and managing security.

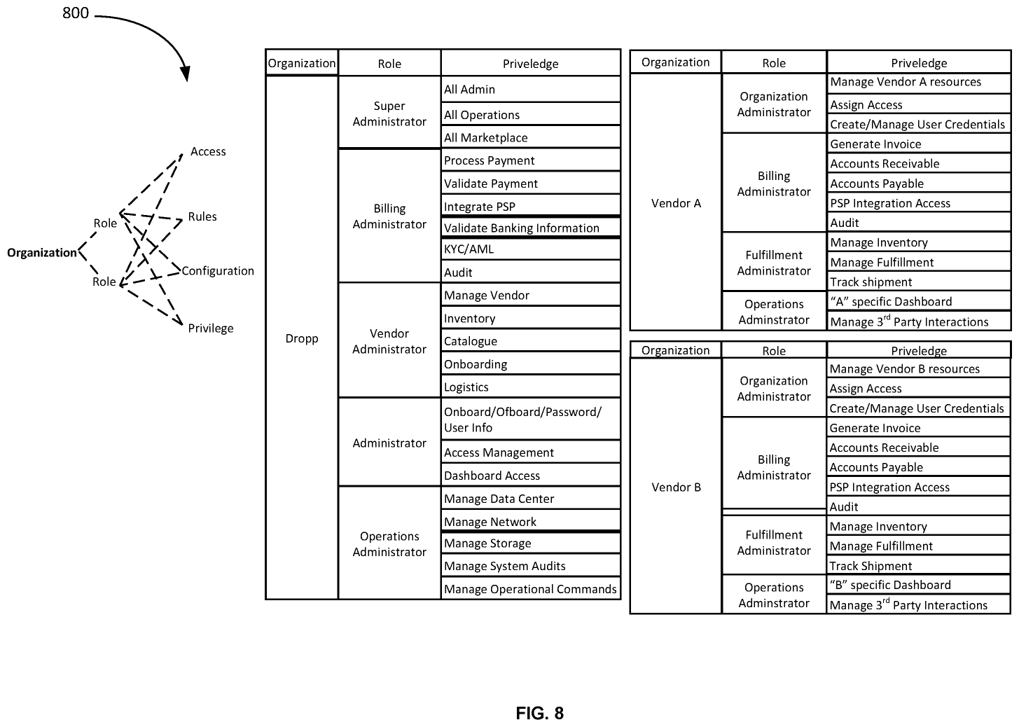

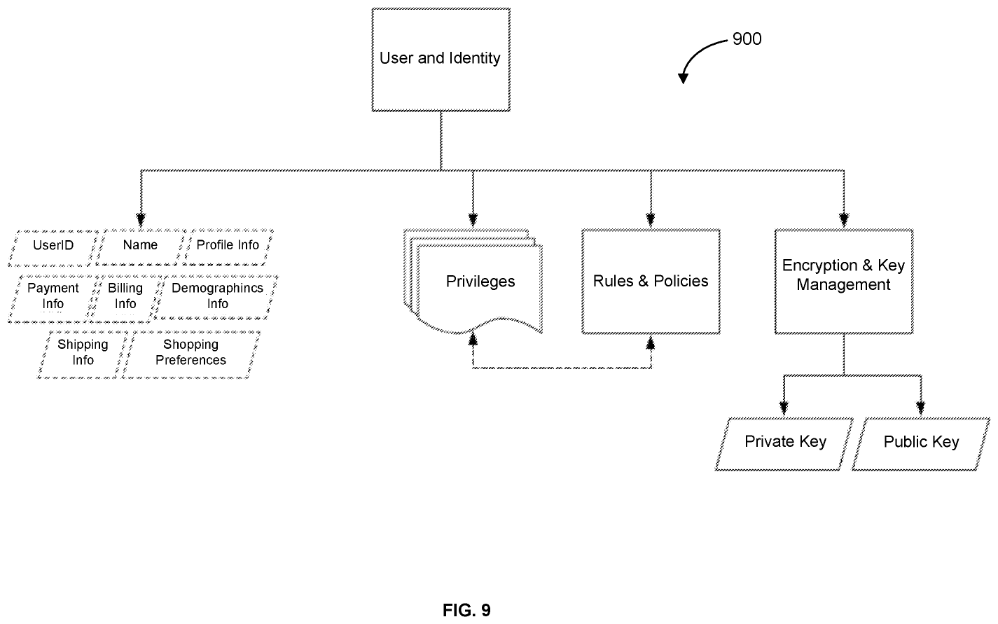

For identity management, in some embodiments, the system and platform, and associated methods, provide for unique identity creation, along with credential, role and access management, as seen, for example, in FIGS. 8 and 9. For user identity management 900, data and information for various users can be stored, maintained, and managed, including, for example, user ID, name, profile information, payment information, billing information, demographic information, shipping information, and shopping preferences—e.g., as implemented or supported in user and identity module 270 of FIG. 2. The platform or architecture 130 can include or run various modules, routines, processes for user identity management, including to establishing or defining user privileges based on various rules and policies. As shown in FIG. 8, various users relating or associated with different organizations or entities that interact, maintain, use, etc. the platform may have different roles (e.g., super, billing, vendor, operations, fulfillment), with each role associated or defined by respective levels of access, rules, privileges, and configurations in the environment (e.g., process payment, validate payment, integrate PSP, audit, manage vendor, inventory, catalog, on-boarding, off-boarding, assign access, generate invoice, track shipment, etc.). The platform can also provide or support encryption and key management, e.g., for private and public keys, for secure communication and access.

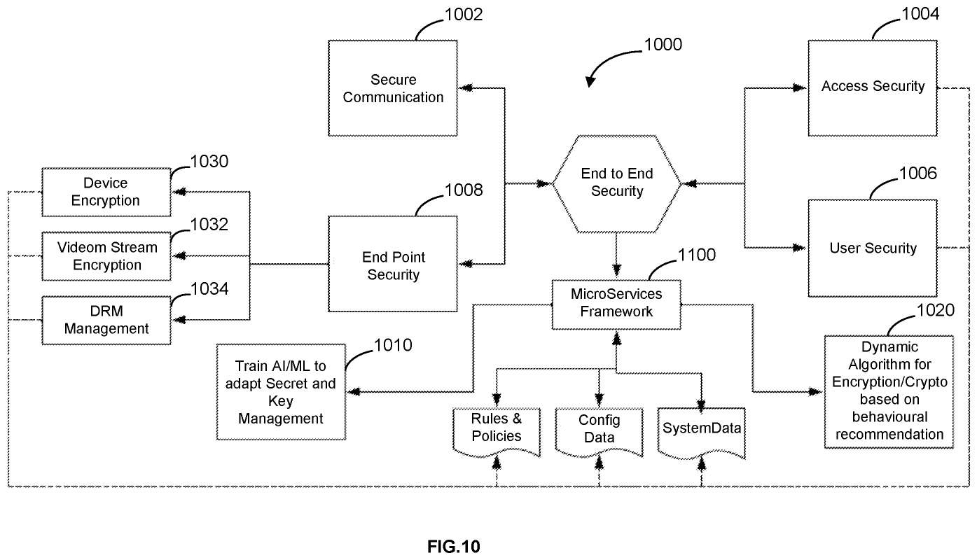

Related to that, security management protects the network or platform from undesirable external access, internal corruption and system errors. In some embodiments, security management is implemented in or supported by security extensions 170 of platform 130 (FIG. 2). Security management, in some embodiments, is illustrated in FIG. 10. In some embodiments, security management includes or encompasses Entity Security, Domain Security, Information/Data Security, and Access Security. Entity Security is security pertaining to the user, asset, enterprise, 3PL, partners and third party entities (e.g., identity, password, credentials, etc.). Domain Security can include the separation of information and access between all entities in the system (segregation of all entities and data). Information/Data Security can moat to protect the data, encryption of the data and access of the data based on access credentials access (anonymization, encryption, access, control, regulatory (PCI), compliance etc.). Access Security prevents unauthorized access or channel (certificates, tokens etc.).

Referring to FIG. 10, in some embodiments, security extensions 170 of platform 130 provides for end to end security 1000 for the network, architecture, or platform. Such end to end security encompasses or comprises secure communications 1002, access security 1004, and user security 1006, as further described herein. In some embodiments, the end to end security also comprises end point security 1008 (e.g., at a user device or head-end device), which is supported or implemented by device encryption 1030, video stream encryption 1032, and Digital Rights Management (DRM) 1034. In some embodiments, security extensions 170 for the end to end security 1000 may utilize or be implemented with a micro-services framework, with access to data and information relating to various rules and policies, configuration, and the system. In some embodiments, security extensions 170 employ AI/ML (e.g., in AI/ML extensions 210), which are trained to adapt secret and key management 1010. In some embodiments, security extensions 170 provides, supports, or implements a dynamic algorithm 1020 for encryption or cryptography based on behavioral recommendations.

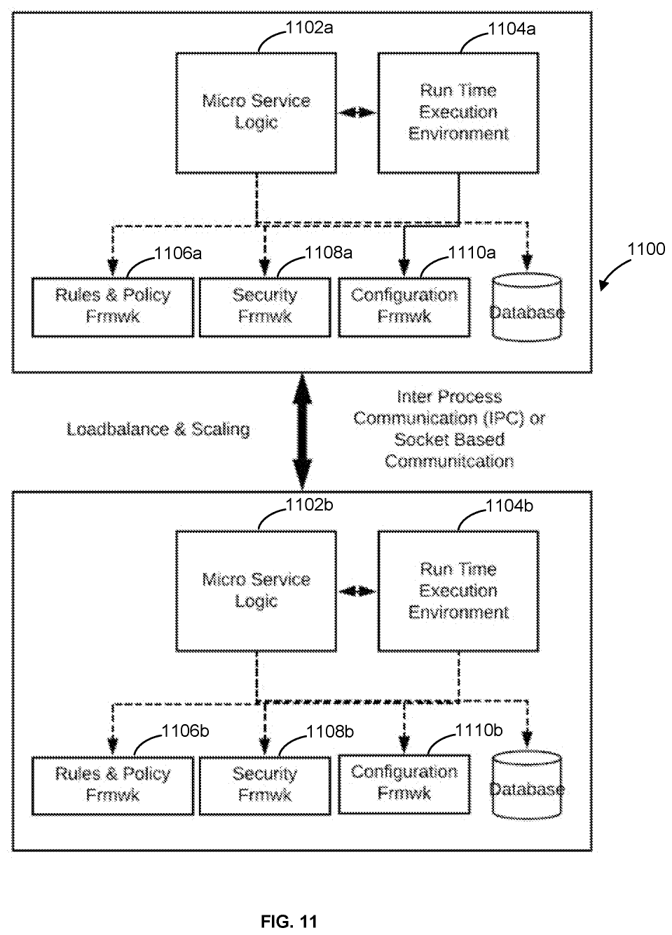

According to some embodiments, the network or architecture may leverage or employ a micro-service based container model 1100, to enable domain specific extension and independent service design/implementation/architecture management. Embodiments of the micro-service model 1100 are illustrated in FIG. 11. Such model 1100 is container-based to isolate, modularize and create a micro-services based run time architecture. In some embodiments, the architecture or platform leverages technology like Docker to provide packaging and distribution of containers. It may also leverage Kubernetes to orchestrate, cluster and manage large set of micro-services and containers.

Referring to FIG. 11, in some embodiments, with the micro-service based container model 1100, each micro-service supporting or implementing an application may comprise or be implemented with its own micro service logic 1102a, 1102b which, when executed, runs in a respective run time execution environment 1104a, 1104b to implement specific frameworks for rules and policy 1106, security 1108, and configuration 1110. The micro-services may communicate through inter process communication (IPC) or socket based communication. The network or platform may perform loadbalancing and scaling of the micro-services in order to optimize utilization of network resources.

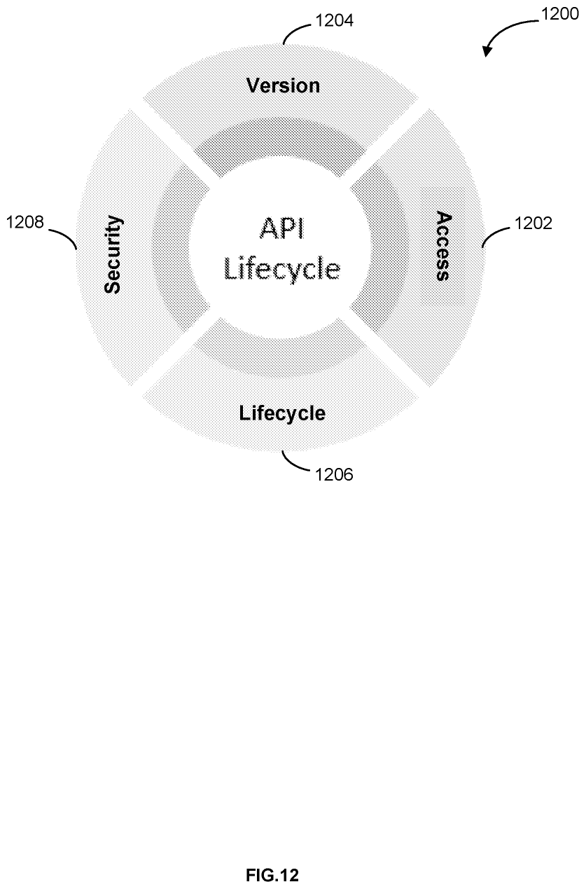

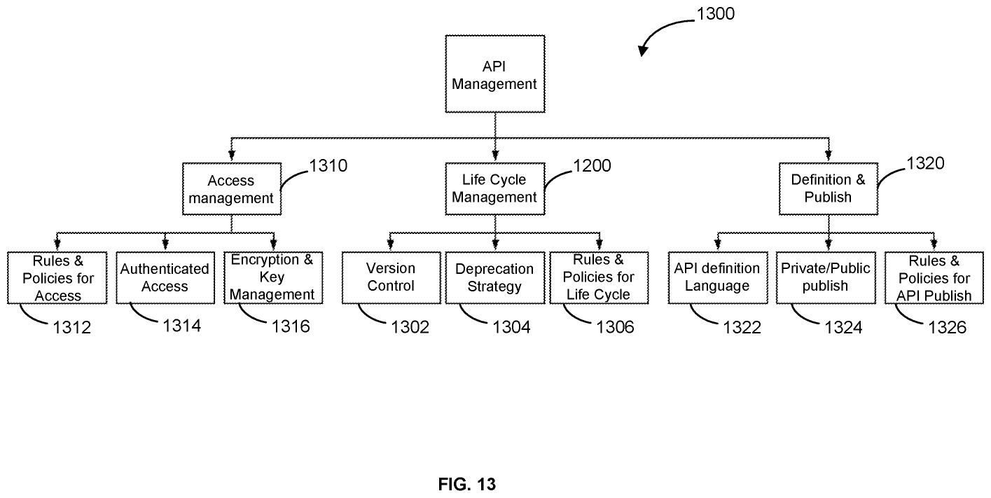

Access to the network, platform, or architecture for providing or supporting shopping directly from a user screen (of a respective user system 20) while viewing a video program, can be made through our or more application programming interfaces (APIs). Such APIs may be updated, modified, changed, deleted, replaced over time, or otherwise managed, according to changes in hardware, software, etc. Embodiments of API management are illustrated in FIGS. 12 and 13.

In some embodiments, processes and systems are provided for life cycle management of such APIs to manage the integration with and from the third party external systems. With reference to FIGS. 12 and 13, systems and methods for such life cycle management 1200 may comprise or entail managing version 1302, 1204 (e.g., version control), access 1202, deprecation strategy 1304, applicable rules and policy for life cycle, etc. of the APIs 1306, 1206 (e.g., based on standards like RAML). For example, while using a PSP Gateway to aggregate and process payments, all new version of APIs by a third party, and all interactions from gateway to, can be managed, thus reducing the need for re-factoring, reducing version mismatch, undesirable access to functionality by unauthorized entities, etc.

With reference to FIG. 13, in addition to life cycle management 1200, systems and methods for API management 1300 also comprises access management 1310 for various APIs. In some examples, API access management 1310 comprises or entails managing applicable rules and policies 1312 for access by various APIs, authenticated access 1314, and encryption and key management 1316. API management may also comprise managing definitions and publishing 1320 for API. In some examples, this includes API definition language 1322, private and/or public publishing 1324, and applicable rules and policies 1326 for API publishing.

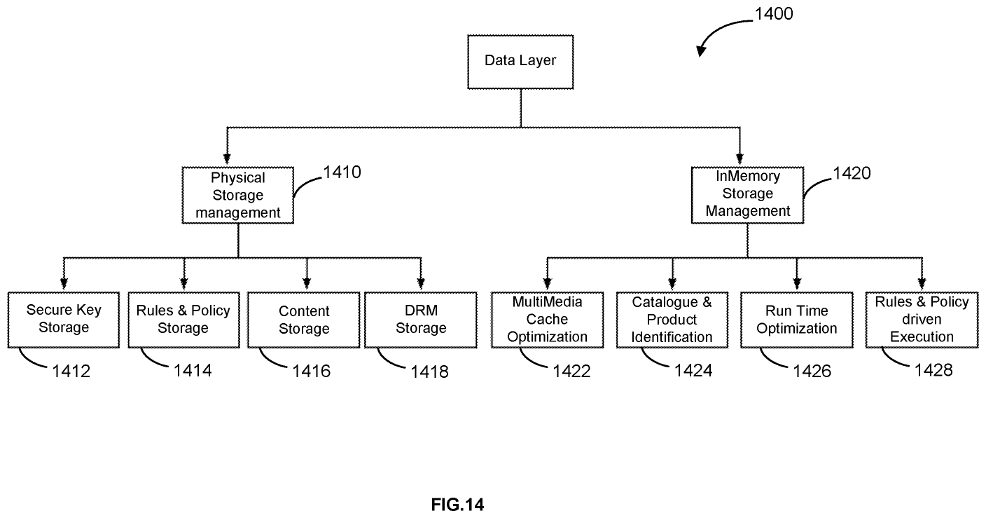

Data and information input, processed, stored, and/or output from the network, platform, or architecture (e.g., input data 140 and output data 150) is aggregated and managed, e.g., using one or more data abstraction, aggregation and management layers, embodiments of which are shown in FIG. 14. Such data management layers can facilitate, support, or provides various services or operations. These include normalizing all data within the platform—for example, all third party data is mapped and normalized to internal consumable structures within the micro-services. The data layers may also provide a multi-storage strategy. In one example, the platform enables the micro-services to leverage the “most suitable” data repository for the services it provides, including standard SQL- or noSQL-based dBases, e.g., documents will be stores in MongoDB, whereas relational information is stored in Postgres or an Oracle-like database, and proprietary data storage extensions. The data layers may also facilitate or support secure storage—e.g., supporting attribute level encryption and hashing to enable secure storage, leverage distributed key management to grant access to view or modify the data.

In some embodiments, as shown in FIG. 14, the data layers provide or support physical storage management 1410 and in memory storage management 1420. Physical storage management 1410 may include storage into particular physical locations data or information for secure key 1412, rules and policies 1414, content 1416, and DRM 1418. In memory storage management 1420 may include storage for multimedia cache optimization 1422, catalog and product identification 1424, run time optimization 1426, and rules and policy driven execution 1428.

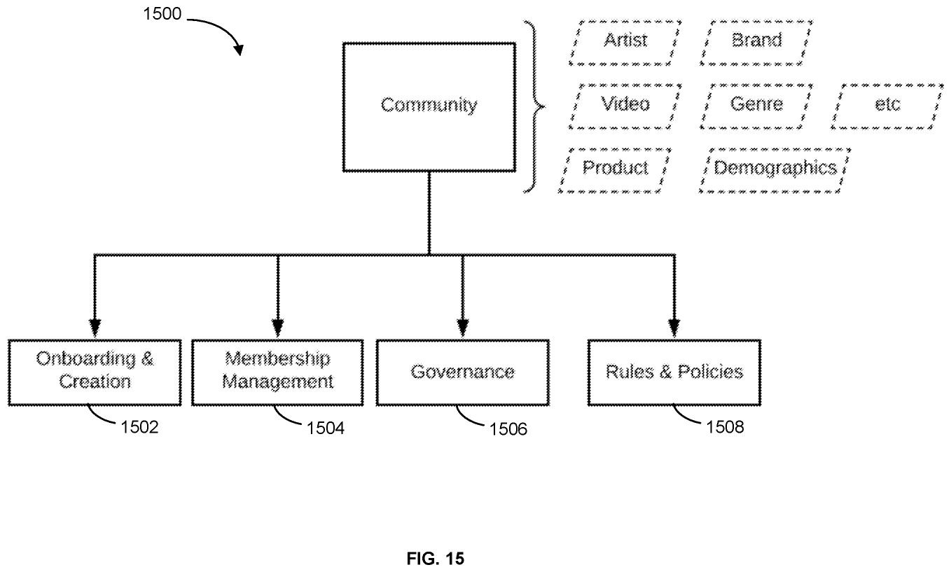

According to some embodiments, the platform or architecture allows or provides or supports the capability for at least partial management 1500 by one or more third parties or communities, as illustrated in FIG. 15. Each community can comprise or relate to, for example, a particular artist, video, product, brand, genre, demographic, etc. For one or more of the various communities, the platform, architecture, or network may provide or support creation and on-boarding of the community 1502, management of membership 1504, governance 1506, and applicable rules and policies 1508. In some embodiments, community processes and operations can be supported or implemented in part by user and identify module 270 and multi-interface integration framework 200 of the Entertainment Commerce platform 130.

In some embodiments, the platform enables third party systems—such as gateways, document scanners, infrastructure and network management systems—to provide critical points of data collection, platform optimization, security, etc.; for example, plans to leverage external document scanners to collect information from disparate invoices etc. This critical framework synergizes the operations of these authorized input devices and management of information. As such, the platform or architecture can leverage the management interfaces of third parties, and represents them in common routines, minimizing the learning curve and ability to utilize bespoke pre-integrated offerings.

Likewise, communities represent similar interests, wants, needs, and desires—for example, as derived from purchasing behavior and facilitate aggregation of the demand from various similar entities (organizations)—based on geographical location, vicinity, SKUs etc. to optimize ordering and fulfillment. Thus, in some embodiments, the platform or architecture provide interfaces to enable precision marketing campaigns and offers from manufacturers to the communities with similar wants, needs and desires. Community enables interfaces—to manually or automatically on-board members, anonymize the information to manufacturers, enable manufactures to build targeted campaigns on published wants, needs and desires, publish and respond to trends on purchasing behaviors, etc. Third party and community management for the network, platform, and systems of the present disclosure are illustrated in FIG. 15.

The platform 130 may operate on various multi-media content which, in some examples, can be stored, maintained, or otherwise managed in content storage management module 150 and/or multi-media asset management 220. This content may be in the form of one or more videos or images (e.g., movies or television programs from one or more content providers, or user-generated videos), real or virtual. The platform 130 makes such content “shoppable” for Entertainment Commerce. In some embodiments, to identify objects or potential items of interest in various video segments, the systems and methods of the present disclosure, including as implemented by the network, platform, or architecture described herein, may employ or utilize computer vision. Computer vision is an interdisciplinary field that has been gaining huge amounts of traction in recent years. The platform 130 utilizes or employs computer vision for object detection. In various applications, object detection aids in pose estimation, vehicle detection, surveillance etc.

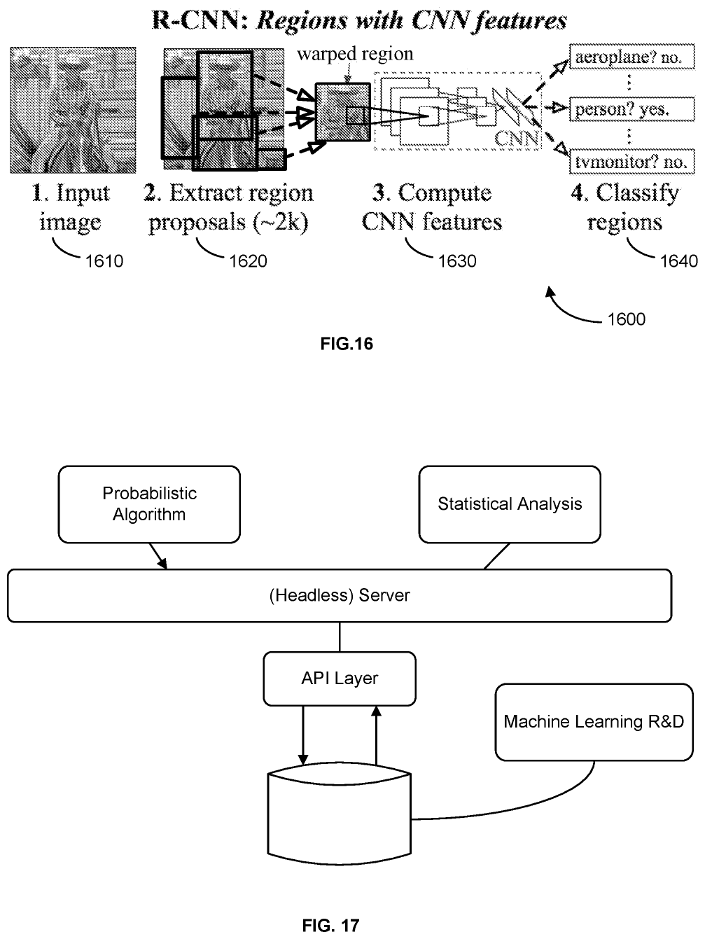

FIG. 16 illustrates object detection and classification 1600, according to some embodiments. In some embodiments, for object detection, the platform 130 (e.g., using multi-media transformation engine 160) analyzes a video segment or image (e.g., frame) and attempts to draw respective bounding boxes around one or more objects of interest to locate it within the image. In some embodiments, the platform 130 may also employ or perform classification process or method in order to classify or categorize the item once it has been identified within the video or image, thereby transforming the multi-media content into a “shoppable” form.

In some embodiments, for object detection and/or classification, multi-media transformation engine 160 may be implemented with, call upon, or work in conjunction with one or more neural network models, such as a Region-based Convolutional Neural Networks (R-CNN), as described in more detail, for example, in Girshick et al., “Rich feature hierarchies for accurate object detection and semantic segmentation,” Proceedings of the IEEE conference on computer vision and pattern recognition, pp. 580-587, 2014, the entirety of which is incorporated by reference. In some embodiments, these neural networks are implemented in or supported by the AI/ML extensions 210 of platform 130 (FIG. 2). In some embodiments, such neural network operates in steps or processes. First, at a process 1610, neural network receives an input image, which can be a portion of a multi-media program or video content received from a user or a content provider. The image may include one or more items of potential, such as various articles of clothing or food. Next, at a process 1620, neural network defines or extracts one or more proposals for various regions in the image. In some examples, using selective search, the neural network identifies a manageable number of bounding-box object region candidates (“region of interest” or “RoI”). Then, the neural network extracts CNN features from each region independently for classification. At process 1630, the neural network computes CNN features. At process 1640, the neural network classifies the regions to identify objects therein.

In some embodiments, the R-CNN protocol utilizes an algorithm that can extract the region and identify the object by comparing it to the similar (learned) objects. Referring to FIG. 16, a protocol like R-CNN can be utilized to identify an object (e.g., as a person wearing a shirt, a hat, a belt, or a shoe; or as a car), but not necessarily to refine and create an exact match of finer details, such as exact type of shirt or hat or belt or shoe that the object might be wearing or the exact brand of car and its options, such as wheel rims or leather type etc. That is, previously developed technology is unable to map a “generic” identification of object to a precise inventory item or “similar” products.

To address this, in some embodiments, the systems and methods of the present disclosure (e.g., as implemented with multi-media transformation engine 160 and AI/ML extensions 210 of platform 130) extend or supplement the object detection and classification techniques, for example, with data and information relating to specific product, services, or items offered by particular vendors or sellers, and modules and processes for operating on the same in connection with the identified/classified objects. In some embodiments, at least a portion of this data or information is provided to the systems and methods directly from the vendors or sellers, e.g., using merchant systems 60, and stored, for example, in vendor management 240 module or supply chain management module 260. This information or data can include multiple views (e.g., front, back, side) or three-dimensional renditions of the respective items, thus facilitating the matching between the displayed objects and their specific inventory counterparts. This information or data for the objects of interest can be included, embedded, or added as “meta data” along with the video segments in which the objects are presented.

According to some embodiments, the systems and methods of the present disclosure—e.g., as implemented in or supported by multi-media transformation engine 160 and AI/ML extensions 210 of Entertainment Commerce platform 130—extend or build on computer vision techniques with artificial intelligence (AI)/machine learning (ML) routines to leverage the extension of object detection using the existing computer vision technologies. Once the object (for example, a human) has been identified in a video segment, frame, or image, the systems and methods make or perform further refinements or processing to the object to identify the potential products of interest. For this, in some embodiments, multi-media transformation engine 160 matches the potential meta data of the products to the inventory of products in the marketplace. The product or service identified is described by the merchant, vendor, or seller utilizing a meta data algorithm. In some embodiments, the systems and methods of the present disclosure extend one or more matching algorithms, such as Cosine or Jaccard, to provide a unique “similar” products matching and predicting the user behavior based on her current and past utilization.

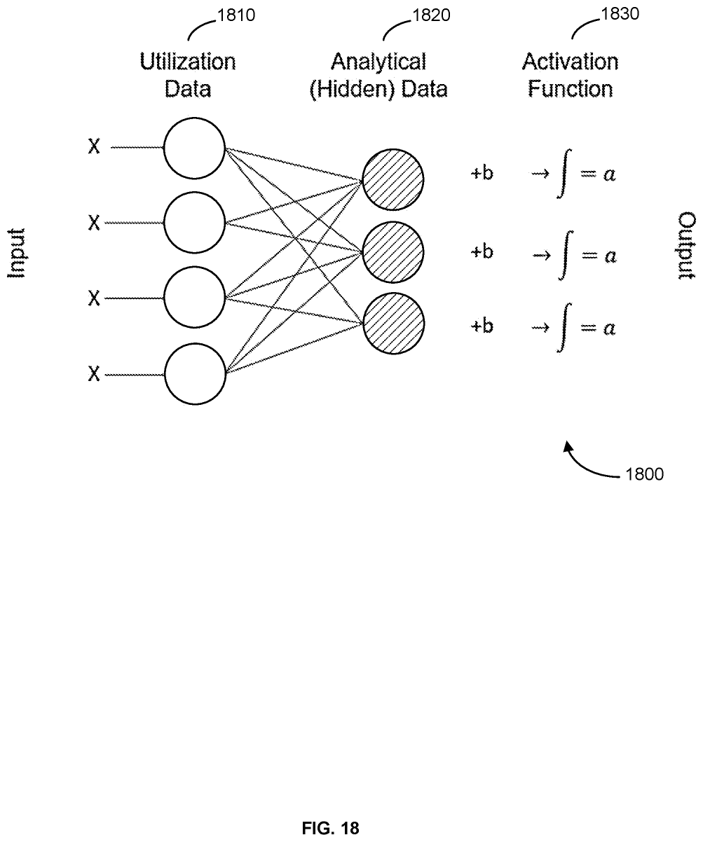

According to some embodiments, for matching, the systems and corresponding methods of the present disclosure employ or use one or more networks for artificial intelligence (AI), machine learning (ML), deep learning (DL), or fuzzy logic models, as illustrated in FIG. 17. In some embodiments, these neural network models are supported by or implemented in AI/ML extensions 210 of platform 130, and can be separate from the network models that perform or implement object detection. In some embodiments, such network model(s) for matching implement a two-part process. First, the network performs smart matching. That is, based on context, utilization, trends, etc., the system matches the product to the wants, of a user. Second, the network or system predicts the utilization and demand, for example, based on desires of the user.

According to some embodiments, for matching user desires, the system, platform, or network can perform or apply one or more of the following processes to measure the matching score between these vectors: Define the context based on the set of data and features. Preprocess the data by removing stop words, stemming list from both features. Find a set of key words from both set of features. Construct Hamming distance, Sorensen-Dice Coefficient extensions and Jaccard similarity matrix. Ranking function to sort these matching scores and find the top (e.g., five) matches and product utilization. Features data may be available where the current context is used for selecting only the relevant set of data and features. Contextual information is used to select the most relevant data for generating recommendations.

In some embodiments, applicable algorithms or processes for matching include algorithms or processes for identifying similarity and for predicting trends/context.

With respect to identifying or determining similarity, matching algorithms such as Cosine or Jaccard can be extended or employed. Cosine is one of the more popular measurement of similarity between two vectors, which measures the cosine of the angle of the vectors of n dimensional.
Given two documents \vec{tₐ} and \vec{t_{b}} their cosine similarity can be calculated as follows:

$$S I {M}_{c} ( \vec{{t}_{a}} , \vec{{t}_{b}} ) = \frac{\vec{{t}_{a}} \cdot \vec{{t}_{b}}}{\vec{{t}_{a}} * \vec{{t}_{b}}}$$

\vec{tₐ} and \vec{t_{b}} are m-dimensional vectors over term T={t₁ . . . tₘ}
   Jaccard compares the data of two sets to check which data are shared and which are distinct. This is important in community management and recommendation.
Jaccard coefficient of text document, compares the sum weight of shared terms as follow:

$$S I {M}_{J} ( \vec{{t}_{a}} , \vec{{t}_{b}} ) = \frac{\vec{{t}_{a}} \cdot \vec{{t}_{b}}}{{\vert \vec{{t}_{a}} \vert}^{2} + {\vert \vec{{t}_{b}} \vert}^{2} - \vec{{t}_{a}} \cdot \vec{{t}_{b}}}$$

The output of Jaccard coefficient ranges between 0 and 1. 1 means \vec{tₐ}=\vec{t_{b}} two objects are the same, while 0 means they are completely different

In some embodiments, the system, platform, or network determines or predicts trend/context based on utilization and purchase history. In some embodiments, the systems and methods may use a deep learning framework (e.g., Deep Belief Network (DBN)) or model (e.g., as implemented or supported in AI/ML extensions 210 of the platform 130) for analyzing the extracted context and to predict the outcome considering the context scenario for matching between expected utilization (by enterprise) and the manufacturing/3PL demand/utilization. This leverages the data trends, history, and utilization to demand or derive the standard demand, in a particular context. In some embodiments, multi-media transformation engine 160 and AI/ML extensions 210 perform one or more of the following processes. For each type of goods, identify the behavioral pattern of the consumption and utilization. Train the DBN model based on the context of the needs and desires. Predict the next utilization of the enterprise by leveraging multi-factor trends (e.g., weather, time of the year, utilization based on predicted employee schedules, etc.). Based on the trends and utilization—and the inventory of all businesses (even those that are not part of the network), and manufacturers—predict likelihood of additional enterprises (who have not yet joined, but have similar characteristics) to join the platform, e.g., for targeted sales.

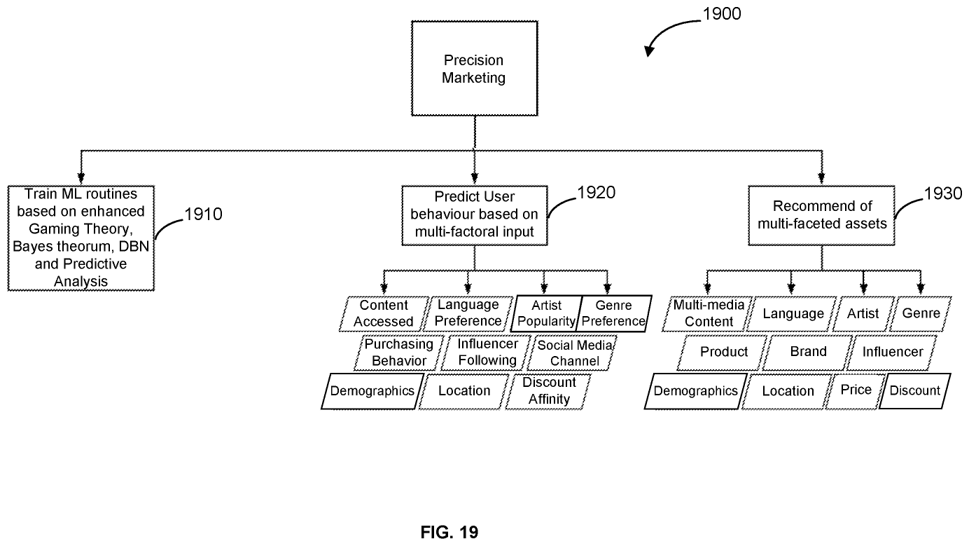

In some embodiments, the multi-factor DBN model may be implemented as a multi-layer neural network 1800, as illustrated in FIG. 18. Neural network 1800 comprises a utilization data layer 1810, analytical (hidden) data layer 1820, and activation function layer 1830.

In some embodiments, an identified item or object is matched to the exact product, service, or item offered or provided by the particular vendor supplying the item. In some examples, the systems and methods (e.g., as implemented in Entertainment Commerce platform 130) enable or allow a vendor or seller of an item or object appearing in a video program to negotiate or enter into an exclusive arrangement with the provider or distributor of that video content so that only the exact product or service matching the displayed item is presented to a user when viewing and “clicking” on the object of interest. Vendor arrangements and agreements can be managed in vendor management module 240.

In some examples, the platform 130 may provide or present information for one or more alternatives that, while not an exact match for the item or object of interest presented in the video, is similar to the displayed item. In this way, a user or viewer may be provided with a range of products, e.g., from high-end to more mass-market, at least one of which may be commensurate or in-line with the user's preferred price point. In some examples, these operations or processes are supported or implemented in the supply chain management module 260 of platform 130. Thus, according to some embodiments, the systems and methods of the present disclosure can implement or provide a broad marketplace or Entertainment Commerce platform for products and services displayed in video segments. The systems and methods identify the objects, match the exact object to the shoppable inventory in the marketplace and perform “similar” matches to the objects which are similar, but not identical, in the inventory of the marketplace. Thereafter, the identified and matched items are presented or otherwise made available to users viewing the video segments, for example, as implemented or supported in the multi-access/multi-channel market place 180, from which they can obtain additional information (e.g., seller or vendor, size, color, price, availability, etc.) and ultimately make a purchase (e.g., as supported or implemented with payment processing 140 of platform 130).

In some embodiments, the systems and methods may employ or use one or more neural networks to perform a classification task to match each identified and classified object to one or more products or services being offered by various vendors. These neural networks can be the same or different from the network(s) performing the object detection and initial classification.

According to some embodiments, the video segments can be processed by the methods, systems, neural networks of the present disclosure (e.g., multi-media transformation engine 160 and AI/ML extensions 210) on an on-going basis, for example, shortly after generation or “filming” so that currently fashionable or trendy items can be provided in the marketplace in close chronological order to the initial presentation of the video content. This potentially heightens or maximizes the impact for the vendors or seller offering such items, for example, if the video segments go “viral.” In some embodiments, older video programs may be processed months or even years after their initial generation so that “classic” or “retro” styles of items (e.g., clothes, shoes, furniture, etc.) can be identified and potentially made available, sourced, or sold by the original or new vendors or sellers. In some embodiments, an entire season or series of a program (e.g., reality television show) can be processed at one time, with rights for the marketplace sold or auctioned in advance to interested vendors or sellers (e.g., analogous to the way that commercials are negotiated or sold).

The systems and methods of the present disclosure thus provide flexibility for content providers and merchants/vendors/sellers to collaborate or cooperate to enable to define and enable the marketplace for items presented or displayed in video segments (e.g., as implemented or supported in market place 180). In some embodiments, vendors and content providers may interact on the platform 130 through vendor management module 240 and content provider management module 250.

In some embodiments, the creation of the products or services in the marketplace environment can include creation of a corresponding entry for the product or service into the marketplace by the respective vendor or seller. The systems and methods may enable or allow meta data for the product or service to be added to the video segment or program, along with video details, such as time stamp, location, scene, video name, etc., and stored or maintained in, for example, content storage management 150 and/or multi-media asset management 220.

In some examples, the systems and methods provide or support the creation of a three-dimensional (3D) or augmented reality model to attach or include with a two-dimensional (2D) rendering of the product or service. In some embodiments, this is accomplished with a multi-layer neural network, for example, as implemented or supported in AI/ML extensions 210.

According to some embodiments, a specialized video player is provided for playing the video segments augmented or supported with the 3D or AR model and meta data. Such specialized video player may be implemented with hardware and/or software, such as an application running one or more computing devices (e.g., such as that described with respect to FIGS. 1 and 2) comprising processors and memory. In some embodiments, the augmented video segments or programs (video file, meta data, etc.) are loaded into the memory database (e.g., content storage management 150 and/or multi-media asset management 220) of the specialized video player. When the loaded video is played, the 3D or AR model is rendered on the video player, for example, as a web player, native application running on a mobile computing device which supports AR rendering. Various video segments, frames, or images are presented to the user viewing a display screen of the computing device, where at least some of the segments or frames include potential items or objects of interest. These objects, which can be identified by using computer visions strategies implemented on the video player, may be selected by the user for obtaining additional information regarding the corresponding product or service, and potentially for purchasing or ordering the same. In some embodiments, the object or item of interest is selected, matched (e.g., using machine learning extensions of Cosine and Jaccard theorems) to the appropriate product or service (or “similar” products or services) for which information is stored or downloaded in the memory of the computer device. In some embodiments, the video player (or computing device running the same) keeps track or maintains session management and profile details, taking into account the user preferences, viewing or product history, demographics and user desires etc. (multi-factors) to show customized products.

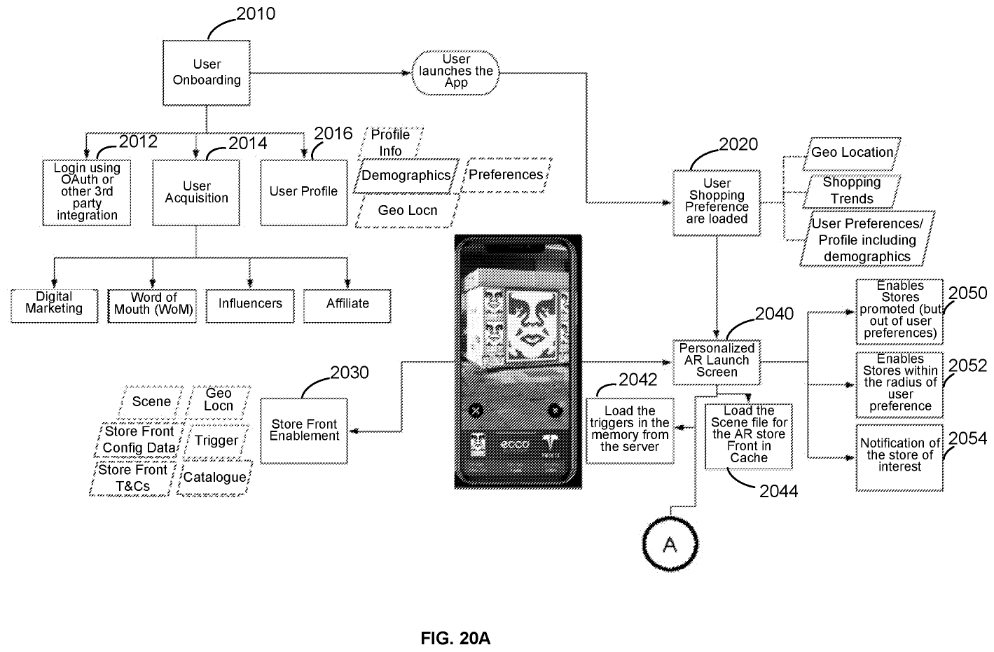

In some embodiments, the systems and method for shoppable media, can provide or support precision or targeted marketing 1900. An embodiment of systems and methods for this precision marketing 1900 is illustrated in FIG. 19.

Referring to FIG. 19, in some embodiments, with precision marketing, the systems and methods can employ one or more neural network models (e.g., as implemented or supported in AI/ML extensions 210 of platform 130 of FIG. 2) to generate one or more predictions 1920 of the demand for various products and services based on distribution and prediction algorithms working on the various information and data input, provided, or processed. That is, the platform and system can predict user behavior based on multi-factor input. In some examples, these factors can include the content accessed by the user, a user's language preference (e.g., English, Spanish, Korean), purchasing behavior, demographics, location, genre preference, and discount affinity. The factors may further include artist popularity, influencer following, and social media channel.

In order to make the predictions, the neural network models are trained 1910 with machine learning routines, for example, based on enhanced Gaming Theory, Bayes Theorem, DBN, and/or predictive analysis.

And based on such predictions, the systems and methods of the present disclosure (e.g., as implemented in the Entertainment Commerce platform 130) may enable, execute or implement—either automatically or manually with human input—bespoke campaigns for various group, clients, or demographics. In some embodiments, this includes making recommendations 1930 of multi-faceted assets of brand or product to one or more users. Such assets can relate, correspond to, or take into account the various factors considered in generating the predictions, including multi-media content, language, artist, influencer, genre, demographics, location, price, and discount.

In some embodiments, the systems and methods can implement an AI, voice-command personal assistant to assist with shopping for the items or objects of interest.

In the current e-commerce world, multiple strategies have been applied in an attempt to guarantee or enable the fit and match of an item (e.g., article of clothing) for particular users, yet returns (e.g., due to wrong fit or wrong size or color or texture) has continued to make a big impact to the offerings. To address this, according to some embodiments, the systems and methods of the present disclosure may also provide, implement, or use virtual reality (VR), augmented reality (AR), and three-dimensional (3D) techniques for further enhancing or extending the experience of a user viewing video segments or programs through her computer display.

While some previously developed technologies or applications allow a user to “try on” a product, such solutions are limited in scope, in particular, being limited to, or taking into account, sizing for a single product (e.g., a pair of shoes).

In order to provide the user with the ability to truly “try” the textures, fit, style, etc. from a multitude of marketplace inventory items on the individual in a virtual or augmented reality environment, in some embodiments, the systems and methods implement, build, maintain, or otherwise provide a metadata library which extends the AR model to define the textures, weight, flows, sizing, fit, etc. of the products. For example, the texture/flow/weight/movement of linen is different from that of a woolen apparel. While these can be defined in a generic fashion, the systems and methods extend standard routines to store such additional data along with the node in the inventory system. Once an object of interest is selected by the user from a video segment displaying the same, the application or system extends the ability to match, recommend, or optimize the product fit based on the desires, environment, body fit etc. of the individual user.

As such, the systems and methods of the present disclosure implement or provide a “virtual dresser.” According to some embodiments, the virtual dresser takes into account multiple factors, such as user preferences, the texture of the apparel, size definition, the flow of garment, fashion trends, etc., to provide the user with the ability to “try” on the product in a virtual reality (VR) or augmented reality (AR) environment. In some embodiments, information and data for supporting the virtual dresser can be stored, maintained, managed, and obtained from user and identity module 270, vendor management module 240, and/or supply chain management module 260 of Entertainment Commerce platform 130).

In some examples, the systems and methods provide or generate an avatar with the body-shape of the user, so that the user can experience what clothes look like on her/him prior to purchase. In some embodiments, the avatar can be generated using input provided by the user, for example, with respect to body type or dimensions (e.g., actual height, weight, head size, neck size, chest and waist measurements, sleeve length, inseam, description as “petite,” “full-figured,” “slim,” “average,” or “athletic”).

In some examples for AR, the systems and methods may utilize one or more cameras of a mobile computing device to take or capture an image of the user (e.g., body type, such as petite, full-figured, average, short, tall, athletic, etc.), on which the product or apparel is applied or placed in order to provide input/feedback, for example, as to fit (e.g., too loose, too tight, too long, too short, just right), flow (e.g., too clingy, too saggy, too poufy, etc.), and so on. This is not limited to apparel, as it can be applied to cosmetics, footwear, home decor etc. According to some embodiments, the systems and methods extend or leverage the Bayes Theorem to predict the probability, e.g., of asset consumption and needs:

$$P ( B \vert A ) = \frac{P ( B \vert A ) P ( A )}{P ( B )}$$

This can be further refined by using the appropriate parameter extensions and probabilistic refinement theorems (such as Total Probability Theorem).

In some embodiments, another option or aspect of an augmented reality (AR) shopping experience relates to movement or travel by the user in one or more locations, for example, Times Square, where the user may encounter images (e.g., on one or more billboards) displaying various products of potential interest. In some embodiments, the systems and methods allow the user take pictures of the billboard, and then process such images, so that a user can be taken or directed to an on-line shopping environment related to billboard. In some embodiments, a user's mobile computing device 100 may be provided with multiple inputs, such as geo fence, scannable trigger, credentials (userid/password, tokens, or any other means), images (such as logos) or any other means of identifying the product that the user might be interested.

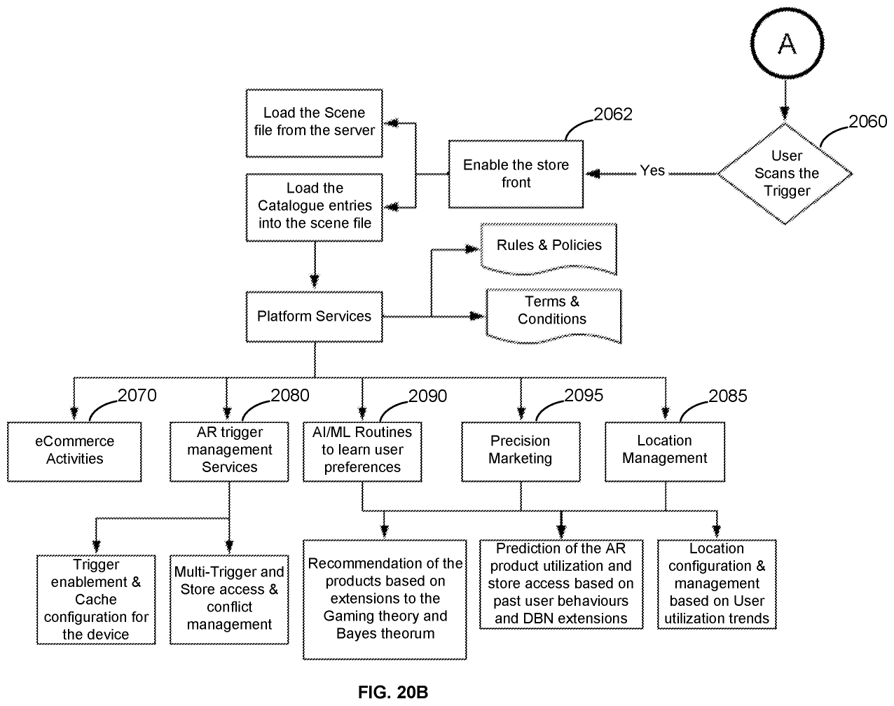

Embodiments of this AR shopping aspect are illustrated in FIGS. 20 through 22. Referring to FIGS. 20A and 20B, the network and platform 130 on-boards users 2010. In some examples, on-boarding 2020 includes the users interacting, for example, through one or more user interfaces implemented or supported in the interface integration framework 200, to input or provide 2012 various information about themselves (e.g., name, user ID, demographics, preferences, etc.), which the platform uses to create a suitable user profile 2016. Other information may be included in the user profile 2016, such as geographic locations through which the user passes). The user profile information can be stored, for example, in user and identity module 270. In some examples, the on-boarding can be triggered or initiated with user acquisition procedures or processes 2014, which may comprise or relating to digital marketing, word of mouth (WoM), social influencers, and various affiliates (e.g., community). After on-boarding, a user may launch on application from her/his computing device 100 for the AR shopping experience. User shopping preferences are loaded 2020 into the platform, which in some examples, may include information about current geographic location, shopping trends (e.g., for clothing, shoes, food, etc.) and other user preferences for the profile. This information supports the AR shopping experience for the user.

Afterwards, as the user moves around various locations, she/he may shoot or record videos that can include items or objects of interest. Some of these items can be, for example, objects displayed on a billboard, poster, etc. (e.g., advertising products or services, such as clothing or a concert or performance by a particular band or artist). In some embodiments, the items or objects of interest can serve or act as triggers to connect the user with the vendors or sellers of the respective products or services).

In some embodiments, a market place AR store front process or operation 2030 is provided so that as a user records video that may include various triggering items or objects, the shoppable media module or platform 130 automatically initiates or opens a store front through which the user may obtain additional information about the corresponding products and services, and ultimately, purchase the same. The store front process 2030 can be supported or implemented using data relating to the scene (containing item or object of interest, acting as triggers), geographic location of where the video is recorded, catalog information for the corresponding products or services, etc. Thus, in some embodiments, the AR store front is presented to the user in real time as the user moves through a location taking video.

In some embodiments, a user may not wish, or be unable, to access the AR store front in real time while recording a video (e.g., because of a lack of network connection). In such cases, the user may elect to initiate the store front at a later point in time by launching a personalized AR screen 2040 on her/his computing device, through which the user can load 2042, 2044 the previously recorded video (including any triggering objects or items captured therein). Here, in some examples, the shoppable media module or platform 130 can provide or support enabling stores promoted by the triggering items 2050, enabling stores within a geographic radius preferred by the user 2052 (which can be different from the location where the video was recorded), and providing notifications to the stores of interest 2054 (e.g., for potential targeted marketing).

With reference to FIG. 20B, in some embodiments, if the user elects to scan a trigger 2060 from the recorded video, the shoppable video module or platform 130 enables the AR store front 2062 through which the user can obtain more information regarding, and potential purchase, the product or service relating to the trigger (i.e., e-commerce activities 2070). Furthermore, in some embodiments, the platform may perform a number of operations or processes to refine, optimize, enhance, or improve the AR shopping activity. In some examples, this may include managing or refining the triggers 2080 (for example, if certain images or objects tend to lead to more purchases). It also may include location management 2085, for example, to determine which locations for billboards or posters are more viewed and/or successful for AR shopping. The operations and processes may also include performing one or more AI/ML routines 2090 to learn user preferences (e.g., training a neural network) and for precision marketing to particular users 2095, as described in more detail herein.

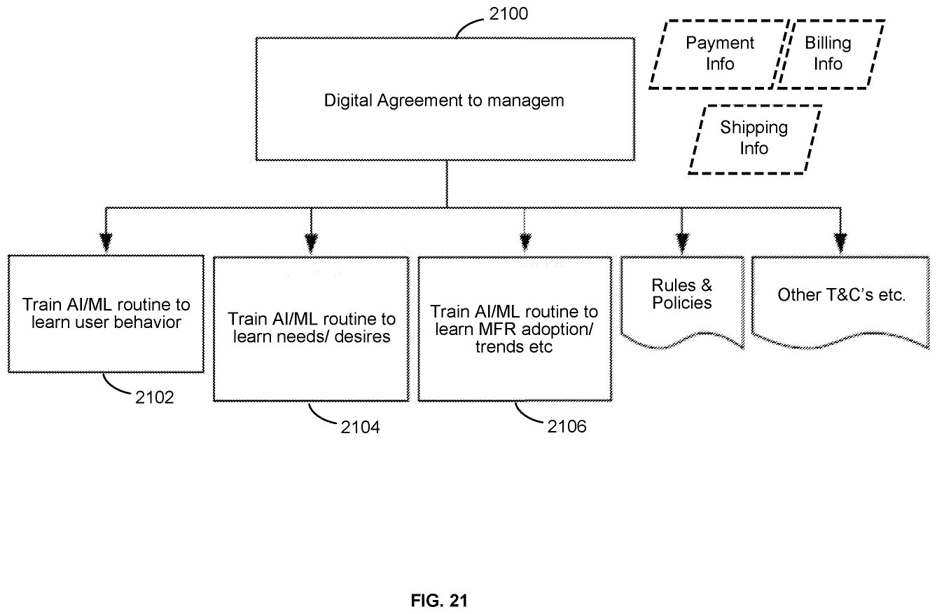

For example, with reference to FIG. 21, using the information collected or provided in connection with the AR shopping experience, one or more neural network models (e.g., as implemented or supported in AI/ML extensions 210 of platform 130) are trained to learn user behavior 2102, the needs/desires of users 2104, current trends 2106, etc. These operations or processes are performed following or in compliance with various applicable rules and policies, terms and conditions, and digital agreements.

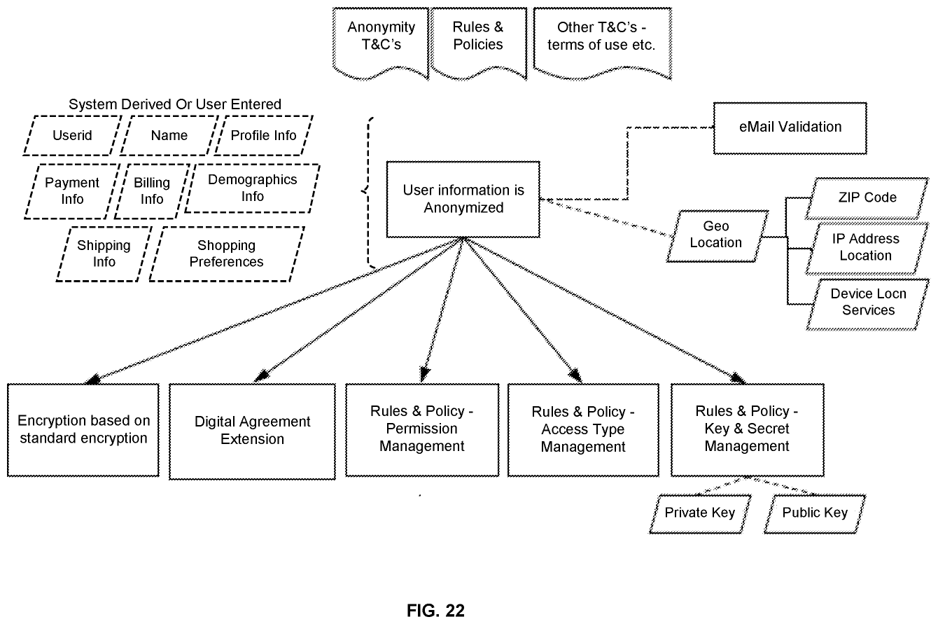

For privacy concerns, in some embodiments, the location and other information provided, collected, generated, or developed from a user in connection with the AR shopping experience can be anonymized and further secured, as shown in FIG. 22. This can include performing encryption and security (e.g., with public and private keys), and restricting or limiting use of the data or information by administering and executing on various rules and policies for permissions and access, for example, as agreed upon by users in applicable terms of use.

The current marketplaces (e.g., online or e-commerce) do not enable a user/business processes to extend the experience between multiple devices. For example, if the user is watching a “shoppable” video on a laptop or television, and he/she wants to examine various products in more detail, previously developed technologies do not provide the ability to extend to other computing devices. This is because limitations exist which may be related to mobile web browsers (e.g., Safari) or operating systems (e.g., iPhone or Android), which is limited in triggers. Furthermore, some native application browsers (e.g., Instagram) do not allow for anything to be manipulated.

To address this, according to some embodiments, the systems and methods of the present disclosure provide or support the ability for a user to extend or transfer a session of the application (e.g., a viewing and interaction with a particular video segment or program) from a laptop, desktop, or smart television onto another device, such as a user's tablet, smart telephone, or other mobile computing device so that the user can “try out” or “examine” the product in augmented reality. Moreover, after the user has examined the object, the systems and methods allow the user to purchase the product or “similar” product from the marketplace participants (e.g., vendor or supplier) using either of the devices.

In some embodiments, the systems and methods of the present disclosure can implement, provide, or support a fully functioning browser within another application's ecosystem. In particular, in some examples, a smart browser is provided that glides or transitions between an app and the native browser on which it is running. The smart browser may be supported or implemented in multi-platform/multi-access application 110, multi-access/multi-channel market place 180, and multi-interface integration framework 200 of the network and platform 130.

The ability to span or extend a shopping experience between multiple devices, in a seamless integrated session, from a traditional e-commerce experience to an augmented reality to visualize and purchase the products between multiple environments is useful to providing an integrated shopping experience.

In particular, in some examples, when a user elects to inspect or view the details regarding some product or item of interest appearing in a video segment, the systems and method provide the user with the option to transfer the session to a mobile computing device (if not on mobile device already) for AR experience, or click on a 3D model to visualize the details on native application, e.g., with the ability to zoom, rotate, flip, or “try on,” etc.

In some embodiments, when the AR mode is selected by the user, the systems and methods will leverage or extend of various technologies to “try” the product on the user or someone else (e.g., a person for whom the product may be intended as a gift). This takes into account multi-factors, such as textures, fit, lighting to create a “real-life” experience of a “fitting room.”

In some embodiments, when the 3D inspection mode is selected, the systems and methods provide the user with an opportunity to leverage multiple factors, such as lighting, colors etc., to inspect the fine details of the product, giving the sense of “real life” in store experience of inspecting the product.

According to some embodiments, these processes or experiences are performed or provided by integrating 3D/AR models into the marketplace as an integral inventory extension. In some embodiments, this includes a metadata definition to define the various objects similarly in the inventory system and the file storage systems which holds the 3D/AR models. The correlation of the inventory to the appropriate model is further enhanced with an AI/ML routine which extends the metadata, learns the user behaviors to recommend “similar” products based on the product views (in 2D, 3D, and AR modes) and to learn the details that interest the user. For example, if a user is looking at a sneaker, depending on the rotation, zoom details, focus (e.g., soles, stitching, laces, inners, etc.), one or more learning routines build or generate a recommendation strategy to promote products which have similar soles, stitching, laces, or inners qualities.

According to some embodiments, various tools and strategies may be employed for the systems and methods of the present disclosure, including the network, platform, architecture, or model for shopping directly from a user screen while viewing a video program. These strategies can include one or more of the following. Model using the open source tools such as Weka, Tensor Flow, etc. Model using the python language set, as it is a commonly used interface. Interact using the REST APIs to limit the dependency on the tool set for analysis. Drive most interactions using a rules and policy based workflow execution environment.

Thus, in some embodiments, the systems and methods of the present disclosure may leverage enforceable rules and policies to define the workflow and vendor/client interaction within the marketplace. This includes a rules and policy engine, which can be part of the shoppable media module 130 (FIG. 1) or platform (FIG. 2), for extending the AR or 3D models, as discussed above, to provide custom interactions and behaviors for the vendor products.

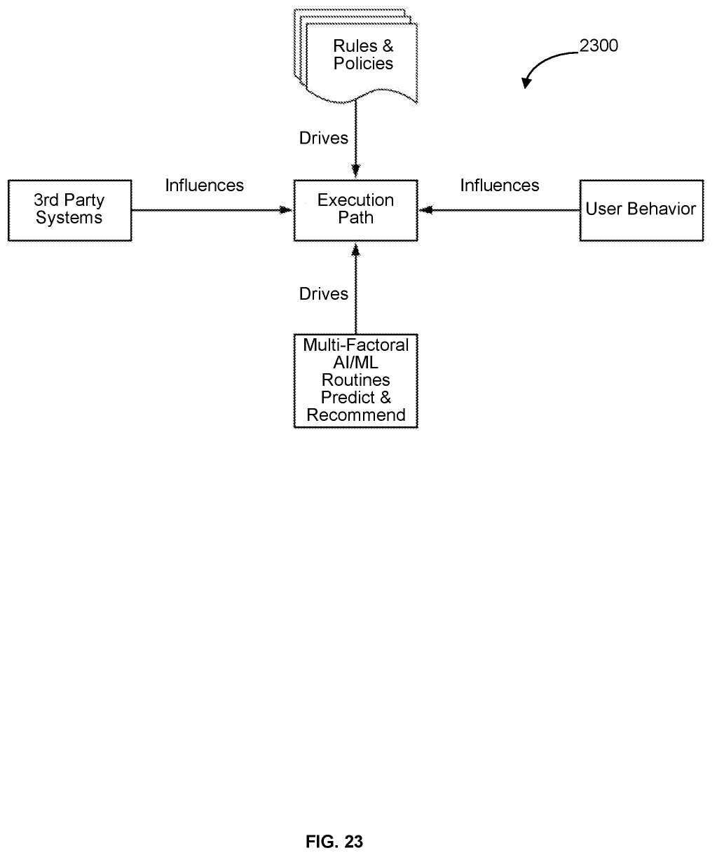

Embodiments of the rules and policy engine 2300 are illustrated in FIG. 23. The rules and policy engine 2300 may define the interactions and application logic based on the abstracted meta data of one or more products and services, and the users' desires, trends, etc. to drive the workflow or interaction behavior for the products/services that are being shopped within the multi-media stream.

The flow implemented by rules and policy engine can also extend the session between multiple devices and the ability extend/manage the commerce interactions within the same session.

In some embodiments, the systems and methods of the present disclosure provide for or support the integration social media with a user's video shopping experience. For example, interactions with the systems and methods (e.g., video player or apps described herein) may also involve linking to users' social media accounts, which may present the user with opportunities to receive promotional merchandise.

Thus, as described herein, systems and methods are provided to enable an integrated experience between multiple devices, multi-media content and marketplace/e-commerce constructs to enable an enhanced experience which leverages multiple user experience paradigms, such as web, native, AR/VR, 3D modelling etc. According to some embodiments, in order to do so, the systems and methods solve the problems previously defined to provide a cohesive experience with multiple vendors enabling transactions in a custom flow involving multiple devices and user experience mediums integrated into a single marketplace. Each vendor or seller of products or services is provided with the tools to set its own business rules, custom behaviors.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures typically represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

1. In an environment where one or more users can view video content on respective user systems, wherein each user system comprising a display screen, a method performed on a computing device for enabling at least one user to shop directly from the display screen on a respective user system while viewing video content, the method comprising:
receiving at the computing device a plurality of video segments, wherein at least one video segment includes an image of a merchandise item;
receiving at the computing device merchandise data from a plurality of merchants, wherein for each merchant, the merchandise data comprises data relating to the same merchandise item of the video segment or a similar merchandise item offered by the merchant, wherein for each of the same or similar merchandise items, the merchandise data comprises a plurality of views, pricing information, and ordering information;
performing object detection by the computing device on the at least one video segment to detect the image of the merchandise item;
classifying the detected image of the merchandise item by the computing device, wherein classifying comprises comparing the detected image of the merchandise item against the merchandise data received from the plurality of merchants;
matching by the computing device the classified detected image of the merchandise item to the same merchandise item and similar merchandise items offered by the plurality of merchants; and
embedding by the computing device metadata for the same merchandise item and similar merchandise items offered by the plurality of merchants into the video segment, wherein the metadata comprises pricing information and ordering information for each of the same merchandise item and similar merchandise items, wherein the embedded metadata allows the at least one user viewing the video segment on the respective user device to shop directly from the display screen for the same merchandise item and similar merchandise items.

2. The method of claim 1, wherein at least one of the classifying or matching comprises performing a Cosine or Jaccard algorithm.

3. The method of claim 1, wherein the computing device implements a neural network.

4. The method of claim 3, wherein the neural network comprises a region-based convolutional neural network (R-CNN).

5. The method of claim 3, wherein the neural network is trained using the merchandise data received from the plurality of merchants.

6. The method of claim 1, comprising receiving at the computing device user behavioral data indicative of the behavior of the at least one user.

7. The method of claim 6, comprising generating a prediction by the computing device regarding the likelihood that the at least one user would want the same merchandise item and similar merchandise items as the merchandise item for which an image is included in the video segment.

8. In an environment where one or more users can view video content on respective user systems, wherein each user system comprising a display screen, a system for enabling at least one user to shop directly from the display screen on a respective user system while viewing video content, the system comprising:
one or more processors and computer memory, wherein the computer memory stores program instructions that when run on the one or more processors cause the system to:
receive a plurality of video segments, wherein at least one video segment includes an image of a merchandise item;
receive merchandise data from a plurality of merchants, wherein for each merchant, the merchandise data comprises data relating to the same merchandise item of the video segment or a similar merchandise item offered by the merchant, wherein for each of the same or similar merchandise items, the merchandise data comprises a plurality of views, pricing information, and ordering information;
perform object detection on the at least one video segment to detect the image of the merchandise item;
classify the detected image of the merchandise item, wherein classifying comprises comparing the detected image of the merchandise item against the merchandise data received from the plurality of merchants;
match the classified detected image of the merchandise item to the same merchandise item and similar merchandise items offered by the plurality of merchants; and
embed metadata for the same merchandise item and similar merchandise items offered by the plurality of merchants into the video segment, wherein the metadata comprises pricing information and ordering information for each of the same merchandise item and similar merchandise items, wherein the embedded metadata allows the at least one user viewing the video segment on the respective user device to shop directly from the display screen for the same merchandise item and similar merchandise items.

9. The system of claim 8, wherein at least one of the classifying or matching comprises performing a Cosine or Jaccard algorithm.

10. The system of claim 8, wherein the one or more processors and computer memory implement a neural network.

11. The system of claim 10, wherein the neural network comprises a region-based convolutional neural network (R-CNN).

12. The system of claim 10, wherein the neural network is trained using the merchandise data received from the plurality of merchants.

13. The system of claim 1, wherein the system receives user behavioral data indicative of the behavior of the at least one user.

14. The system of claim 13, wherein the system generates a prediction regarding the likelihood that the at least one user would want the same merchandise item and similar merchandise items as the merchandise item for which an image is included in the video segment.
